(19) United States
(12) Patent Application Publication
(10) Pub. No.: US 2016/0150196 A1
(43) Pub. Date: May 26, 2016

(54) MOVEMENT AND DISTANCE TRIGGERED IMAGE RECORDING SYSTEM

(71) Applicant: Jon Patrik Horvath, San Francisco, CA (US)

(72) Inventor: Jon Patrik Horvath, San Francisco, CA (US)

(21) Appl. No.: 14/948,369

(22) Filed: Nov. 22, 2015

Related U.S. Application Data
(60) Provisional application No. 62/084,029, filed on Nov. 25, 2014.

(51) Int. Cl. H04N 7/18; H04N 5/232

(52) U.S. Cl. CPC H04N 7/188; H04N 5/23203; H04N 5/23296; H04N 5/23212; H04N 5/23293

(57) ABSTRACT

A method and apparatus can include: providing a threshold; receiving a signal with a camera module, the signal from a tag; determining a location of the tag relative to the camera module based on receiving the signal from the tag, and determining the location includes determining a distance between the tag and the camera module; capturing an image based on the threshold being crossed and the tag being within a frame of the camera module; and recording metadata for the image.

### CROSS-REFERENCE TO RELATED APPLICATIONS

This claims priority benefit to all common subject matter of U.S. Provisional Patent Application Ser. No. 62/084,029 filed Nov. 25, 2014. The content of this application is incorporated herein by reference in its entirety.

### TECHNICAL FIELD

This disclosure relates to recording devices, more particularly an image recording device having automated relational tracking with movement and distance recording triggers.

### BACKGROUND

In recent times, the sports action camera market has expanded rapidly disrupting the digital imaging industry, which was largely focused on video, low end point and shoot, and SLR cameras. Point of view (POV) sports action cameras have taken significant share of this market becoming the principal means of recording action and adventure related sports.

With the expansion of the POV sports camera technology, many manufactures have begun to offer increasingly feature rich products. In order to compete in the POV sports camera market, products must be generally small, light, rugged, easy and fast to setup, mobile, highly integrated, feature rich, and provide exceptionally effective image capture.

As the number of videos and images captured with POV sports cameras has grown, consumers and producers have recognized a major limitation of POV sports cameras; first-person perspective becomes redundant and capturing second-person or third-person perspective is difficult or impractical without a dedicated camera operator. A related problem arises when multiple cameras are used, a surfeit of footage is regularly created and consumes a prohibitive number of man-hours to filter and edit.

Prior developments have attempted to solve these problems in various ways yet have failed to provide a simple yet complete solution. Offering second-person or third-person perspective without a dedicated camera operator while reducing prohibitive amounts of filtering and editing requirements remains a considerable problem for the sports action camera market.

Most prior developments have attempted to solve the problem by using a stationary piece part solution to aim a separate, non-integrated video recording device at a subject. This line of development is prohibitively bulky, clumsy to use, slow to set up, and immobile.

Thus, solutions have been long sought but prior developments have not taught or suggested any complete solutions, and solutions to these problems have long eluded those skilled in the art. Thus, there remains a considerable need for devices and methods that can provide automated, integrated, and effective relational tracking, framing, filming, filtering, and editing capabilities for the sports camera market.

### SUMMARY

An image recording system and methods, reducing the amount of luck and skill required to capture difficult shots, providing significantly lower power, memory, and time requirements, are disclosed. The image recording system and methods include: providing a threshold; receiving a signal with a camera module, the signal from a tag; determining a location of the tag relative to the camera module based on receiving the signal from the tag, and determining the location includes determining a distance between the tag and the camera module; capturing an image based on the threshold being crossed and the tag being within a frame of the camera module; and recording metadata for the image.

Other contemplated embodiments include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The image recording system is illustrated in the figures of the accompanying drawings which are meant to be exemplary and not limiting, in which like reference numerals are intended to refer to like components, and in which:

FIG. 1 is an exemplary embodiment of an image recording system.

FIG. 2 is a setup display for the image recording system of FIG. 1.

FIG. 3 is a filter display for the image recording system of FIG. 1.

FIG. 4 is a merged display for the image recording system of FIG. 1.

FIG. 5 is a block diagram of the tag of FIG. 1.

FIG. 6 is a block diagram of the camera modules of FIG. 1.

FIG. 7 is a control flow for the image recording system of FIG. 1.

FIG. 8 is a control flow for a burst mode for the image recording system of FIG. 1.

FIG. 9 is a control flow for a video mode for the image recording system of FIG. 1.

FIG. 10 is a control flow for a burst sequence mode for the image recording system of FIG. 1.

FIG. 11 is a control flow for a leash mode for the image recording system of FIG. 1.

FIG. 12 is a block diagram of the eyeglass viewfinder of FIG. 1.

FIG. 13 is a control flow for an eyeglass viewfinder mode for the image recording system of FIG. 1.

FIG. 14 is an editing control flow for an embodiment of the image recording system of FIG. 1.

FIG. 15 is a setup control flow for an embodiment of the image recording system of FIG. 1.

### DETAILED DESCRIPTION

In the following description, reference is made to the accompanying drawings that form a part hereof, and in which are shown by way of illustration, embodiments in which the image recording system may be practiced. It is to be understood that other embodiments may be utilized and structural changes may be made without departing from the scope of the image recording system.

When features, aspects, or embodiments of the image recording system are described in terms of steps of a process, an operation, a control flow, or a flow chart, it is to be understood that the steps can be combined, performed in a different order, deleted, or include additional steps without departing from the image recording system as described herein. As used herein, the term image is used generally to refer to video images and still images unless otherwise specified within the context of a specific usage.

The image recording system is described in sufficient detail to enable those skilled in the art to make and use the image recording system and provide numerous specific details to give a thorough understanding of the image recording system; however, it will be apparent that the image recording system may be practiced without these specific details.

In order to avoid obscuring the image recording system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGS. Generally, the image recording system can be operated in any orientation.

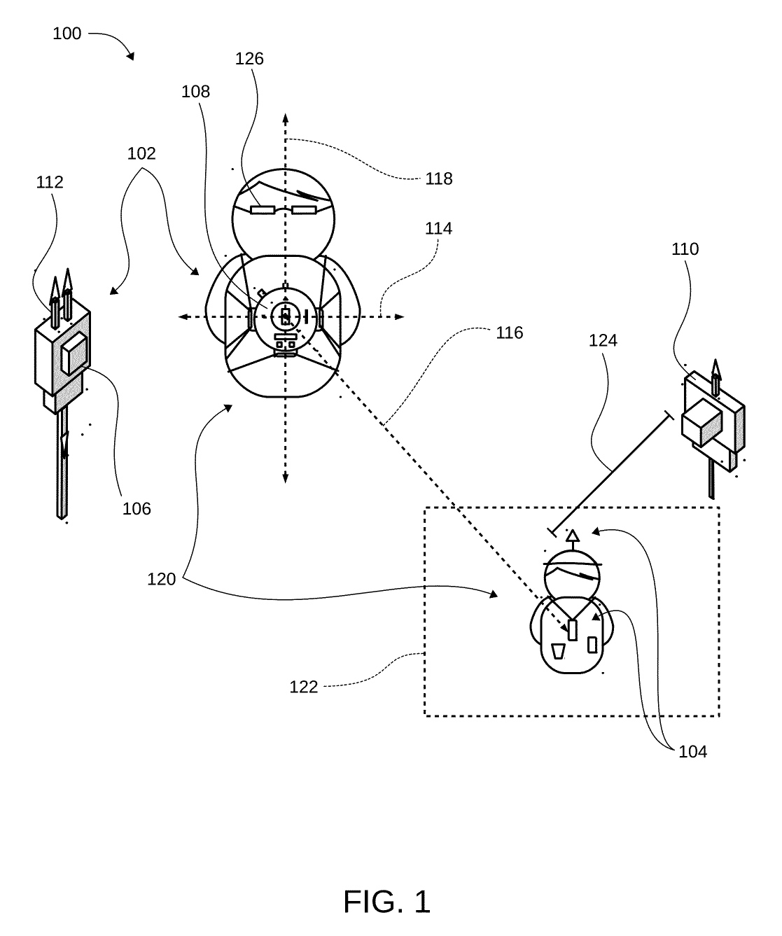

Referring now to FIG. 1, therein is shown an exemplary embodiment of an image recording system 100. In one exemplary embodiment, the image recording system 100 is depicted as including camera modules 102 in communication with each other and in communication with tags 104.

The camera modules 102 can include a first camera module 106, a second camera module 108, and a third camera module 110. The first camera module 106 can be a multi antenna camera module with antennas 112 spaced apart along an X-axis 114, a Y-axis 116, or a Z-axis 118. The antennas 112 on the first camera module 106 can be internal to the first camera module 106 or external as is depicted.

The second camera module 108 can be a wearable camera module anchored to a user 120 with a harness. The second camera module 108 can further include the antennas 112 internally mounted within loops, which anchor the harness to the second camera module 108. The antennas 112 within the second camera module 108 can be offset in the X-axis 114, Y-axis 116, or the Z-axis 118.

The third camera module 110 can be a single antenna camera module having only one of the antennas 112 extending from the third camera module 110. As is depicted, a single one of the antennas 112 extends vertically along the Z-axis 118 away from a body of the third camera module 110. In alternative embodiments the antenna 112 of the third camera module 110 could be mounted within the third camera module 110.

It is contemplated that the camera modules 102 can be worn by one of the users 120, affixed to a moveable platform, or mounted in a fixed position. It is contemplated the moving platform can include vehicles, such as automobiles, aircraft, and surface or under-water vessels. It is contemplated that the vehicles can further include remote or self-piloted vehicles.

The tags 104 can be worn by the users 120, affixed to a moveable platform, or mounted in a stationary position. The moveable platform can include vehicles similar to those described as moveable platforms contemplated for the camera modules 102.

In the current exemplary embodiment, the tags 104 are depicted as being a mounted tag, a cellular device, or a symbol. The tag 104 in the form of the mounted tag can be a purpose built tag for use with camera modules 102 and can be mounted to a lanyard or to a helmet.

The tag 104 in the form of the cellular device can be a cellphone, a watch, or a tablet. The tag 104 in the form of the symbol can be a shape and color for easy recognition by computer vision such as a trapezoid of a solid color. For example, if the symbol is a red trapezoid, the camera modules 102 viewing the symbol will be able to determine the orientation of the symbol as discussed in greater detail below with regard to FIG. 6.

The camera modules 102 can target and track the tags 104. As an illustrative example, the camera modules 102 can track the tags 104 by determining the position of the tags 104 along the X-axis 114, Y-axis 116, and the Z-axis 118. In this illustration, the X-axis 114 could correspond to a horizontal axis, the Z-axis 118 could correspond to a vertical axis, and the Y-axis 116 could correspond to a distance axis.

It is contemplated that the camera modules 102 could target and track the tags 104 by moving or repositioning portions of the camera modules 102 in arcs emanating from the camera modules 102 to maintain the tags 104 at a constant position within a frame 122. It is contemplated that the X-axis 114 and the Y-axis 116 could be used to determine a distance 124 for zoom and focus, while simultaneously providing a pan angle along the X-axis 114. The Z-axis 118 combined with the distance 124 from the camera modules 102 to the tags 104 could further provide a tilt angle along the Z-axis 118.

It is contemplated that the camera modules 102 and tags 104 can be in two way communications when the tags 104 are in range of the camera modules 102. The communications between the camera modules 102 and the tags 104 can be used to determine a position of the tags 104 relative to the camera modules 102.

It has been discovered that the communications between the camera modules 102 and the tags 104 can allow the camera modules 102 to track the position of the tags 104 without any information from outside the image recording system 100 allowing the image recording system 100 to be completely self-contained and deliver hands free, well framed shots of the users 120 whether indoors or outdoors in remote locations.

It has further been discovered that the camera modules 102 can use the position of the tags 104 to track the users 120 and to implement recording options automatically without receiving input from a user 120 and that the camera modules 102 can be dynamically adjusted to ensure that the camera modules 102 are tracking the users 120 and positioning the users 120 correctly within the frame 122.

It is contemplated the camera modules 102 can target and track the tag 104 using various locating schemes. These locating schemes can include time of flight two way ranging, angle of arrival, or time difference of arrival. Other sensor readings can be implemented to improve, supplement, or complement the various methods.

The first camera module 106 is further depicted including an eyeglass viewfinder 126 as an alternative to the locating schemes. The eyeglass viewfinder 126 can be used by the one of the users 120 to adjust the direction, focus, or zoom of the camera modules 102 and thereby allow manual control of the camera modules 102.

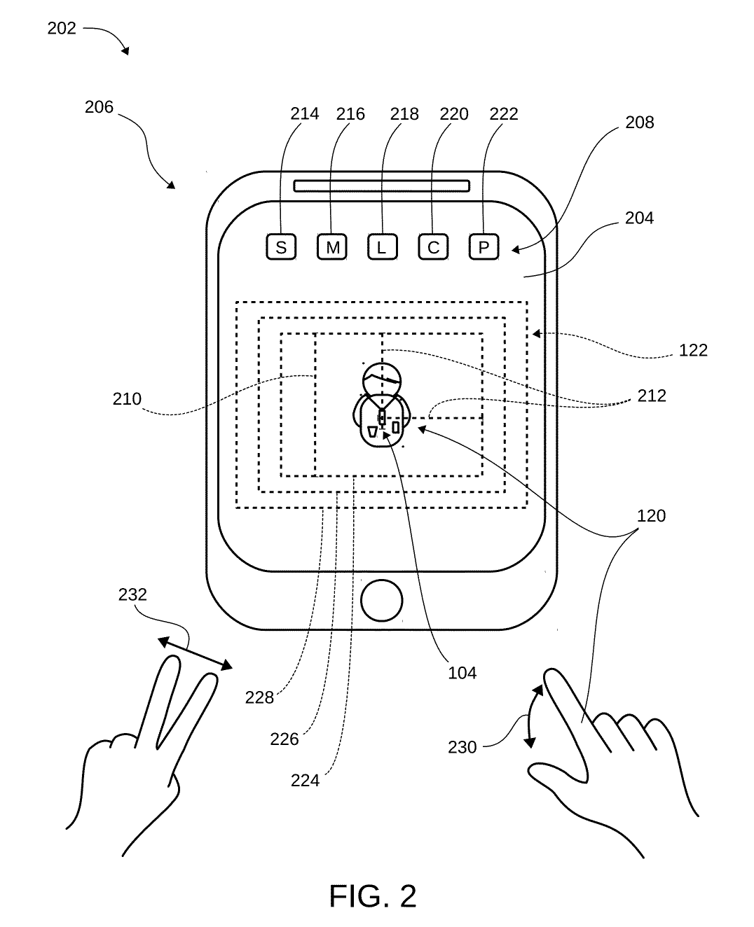

Referring now to FIG. 2, therein is shown a setup display 202 for the image recording system 100 of FIG. 1. The setup display 202 can include a display 204 of a user device 206. The user device 206 is depicted as a tablet computer; however it is to be understood that the display 204 can be on the camera modules 102 of FIG. 1, the tags 104, a watch, a smartphone, or a computer.

The user 120 wearing the tags 104 is shown displayed on the display 204. The frame 122 indicators are depicted around the user 120. The display 204 is further depicted as having frame selection buttons 208.

The frame selection buttons 208 are shown near a top of the display 204; however, it is contemplated that the frame selection buttons 208 can be physical buttons on the user device 206. The frame selection buttons 208 can be selected by the user 120 to determine a height 210 of the frame 122.

As used herein, the height 210 of the frame 122 means the vertical distance of an image around the tag 104 captured by the camera modules 102 measured at the tag 104. The frame 122 of an image captured by the camera modules 102 includes the height 210 of the frame 122 as well as a placement 212 of the tags 104 within the frame 122.

As used herein the placement 212 of the tag 104 within the frame 122 means the distance of the tag 104 from the top and bottom of the frame 122 as well as the distance of the tag 104 from the left and right sides of the frame 122.

The height 210 of the frame 122 can be maintained by the camera modules 102 with dynamic zoom adjustments based on how far the distance 124 of FIG. 1 of the user 120 is from the camera modules 102. The placement 212 of the frame 122 around the user can be maintained by the camera modules 102 with tilt and pan adjustments to maintain the placement 212 of the tag 104 within the frame 122.

The user 120 can select the height 210 of the frame 122 by selecting one of the frame selection buttons 208. In one contemplated embodiment the frame selection buttons 208 can include a small selection button 214, medium selection button 216, a large selection button 218, a custom selection button 220, and a position selection button 222.

The small selection button 214 can be selected by the user 120 to select a small pre-determined frame 224 around the tag 104. It is contemplated that the small pre-determined frame 224 can be used to capture detailed and intimate images of the user 120. In some embodiments the small pre-determined frame 224 can be the frame 122 extending from the torso of the user 120 to just above the head of the user 120. In other embodiments the small pre-determined frame 224 can be the frame 122 around the entire user 120 while still excluding most of the surroundings.

The medium selection button 216 can be selected by the user 120 to select a medium pre-determined frame 226 around the tag 104. It is contemplated that the medium pre-determined frame 226 can be used to capture more of the surroundings of the user 120 than the small pre-determined frame 224.

The large selection button 218 can be selected by the user 120 to select a large pre-determined frame 228 around the tag 104. It is contemplated that the large pre-determined frame 228 can be used to capture more of the surroundings of the user 120 than the medium pre-determined frame 226 and can provide a large field of view.

The custom selection button 220 can be selected by the user 120 to customize the height 210 of the frame 122 around the tag 104. The user 120 is shown using a pinching gesture 230 to resize the height 210 of the frame 122 around the tag 104. It is contemplated that the frame 122 will have an aspect ratio so changing the height 210 of the frame 122 will also change the width of the frame to maintain the aspect ratio of the frame 122. It is contemplated that other gestures can be used to resize the height 210 of the frame 122 around the tag 104 such as a dragging gesture 232 for dragging a side or a corner of the frame 122.

The position selection button 222 can be selected by the user 120 to reposition the placement 212 of the tag 104 within the frame 122. Once the user 120 selects the position selection button 222, the user 120 can use the dragging gesture 232 to drag the frame 122 around the display 204 and change the placement 212 of the frame 122 relative to the tag 104.

It is contemplated the height 210 and placement 212 of the frame 122 for each of the camera modules 102 can be individually set up using the frame selection buttons 208. It is further contemplated that multiple camera modules 102 can be set up together using the frame selection buttons 208.

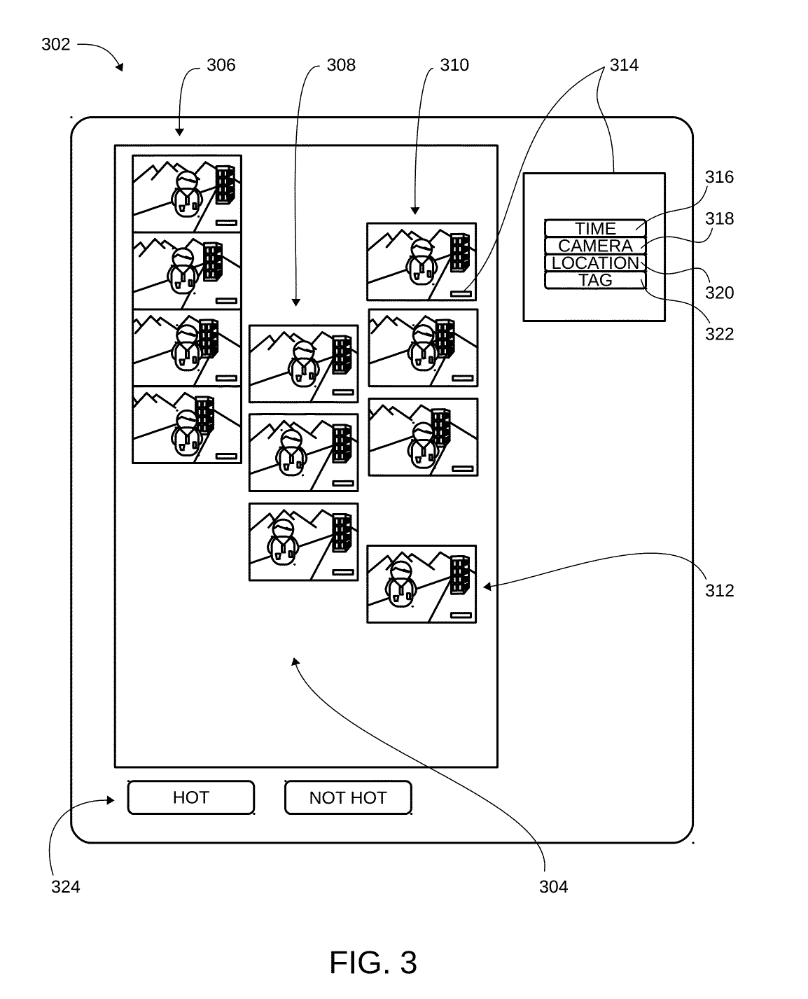

Referring now to FIG. 3, therein is shown a filter display 302 for the image recording system 100 of FIG. 1. The filter display 302 can be displayed on the user device 206 of FIG. 2.

The filter display 302 is depicted having images 304. The images 304 can include motion videos 306 collected by the first camera module 106 of FIG. 1, burst sequence images 308 from the second camera module 108 of FIG. 1, burst images 310 from the first camera module 106 of FIG. 1, and still images 312 from the first camera module 106.

It is contemplated that the motion video 306 can include standard frame rate video collected in bursts or can include high frame rate video collected in bursts while the standard frame rate is captured continuously during operation or captured for longer bursts than the high frame rate video. For illustrative purposes, the standard frame rate can be 24 to 30 frames per second while the high frame rate can be above 30 frames per second such as 60, 120, or 300 frames per second. It is contemplated that the high frame rate video of the motion videos 306 can be collected independent or dependent of whether the standard frame rate video is being captured.

As the filter display 302 shows, the camera modules 102 of FIG. 1 can be set to function in more than one mode as is depicted by the burst images 310 and the still images 312 from the same first camera module 106. For illustrative purposes, the burst sequence images 308 can maintain the frame 122 of FIG. 1 in the same position relative to the background while the placement 212 of FIG. 2 of the tag 104 of FIG. 1 is allowed to move through the frame 122. Conversely, in the still images 312, the burst images 308, and the motion videos 306, the placement 212 of the tag 104 within the frame 122 does not change.

The images 304 of filter display 302 are also depicted having metadata 314 associated therewith. The metadata 314 can include a time of capture 316, a camera module ID 318 for the camera module 102 that captured the image 304, a location 320 where the camera module 102 was located when the image 304 was captured, and a tag ID 322 for the tag 104 that the camera module 102 was targeting when the image 304 was captured and which can be correlated with the user 120 of FIG. 1 wearing the tag 104. It is further contemplated that the metadata 314 can include linear acceleration and speed, rotational speed, and altitude.

The images 304 are depicted organized and synchronized by the time portion of the metadata 314. It is contemplated that the user 120 can select to display the images 304 based on other aspects of the metadata 314. It is contemplated that multiple different segments of the motion videos 306 or other images 304 can be captured and synchronized together based on the metadata 314.

The metadata 314 can be displayed when one of the images 304 is selected by the user 120. The filter display 302 further includes filter buttons 324. The user 120 can select one of the images 304, a sequence of the images 304 or even many of the images 304 based on the metadata 314 and use the filter buttons 324 to include or remove the images 304 from the filter display 302. That is, the user 120 can select the images 304 and then classify them as “Hot” and keep the images 304 or “Not Hot” and remove the images 304.

Illustratively, it is contemplated that the filter display 302 can display multiple motion videos 306 and the user 120 can select a portion of one of the motion videos 306 to discard. The other two portions of the motion videos 306 can be stitched together into one motion video 306 based on the time when the motion videos 306 were taken or other portions of the metadata 314. It is further contemplated that the still images 312, the burst sequence images 308, or the burst images 310 can be flagged as transitions between multiple portions of the motion videos 306 and can be inserted between the motion videos 306.

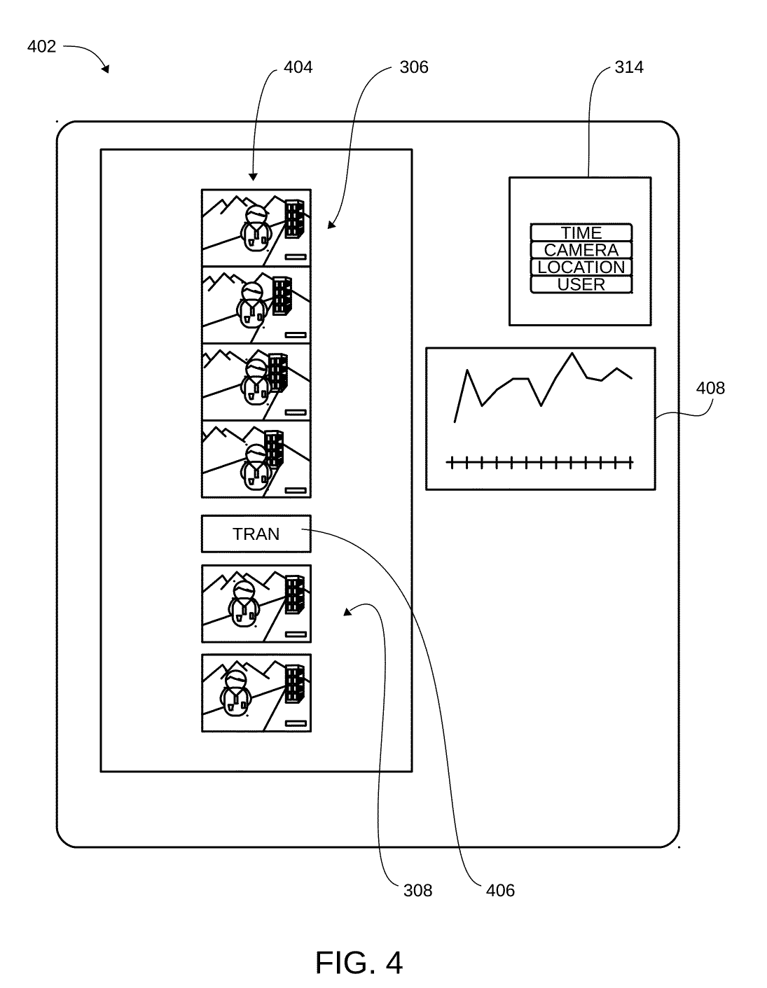

Referring now to FIG. 4, therein is shown a merged display 402 for the image recording system 100 of FIG. 1. The merged display 402 can be displayed on the user device 206 of FIG. 2.

Illustratively, the merged display 402 is shown with the images 304 of FIG. 3 including the motion videos 306 and the burst sequence images 308 merged into a single image sequence 404. The image sequence 404 is further shown including a transition 406 between the motion videos 306 and the burst sequence images 308. It is contemplated that the transition 406 can be selected by the user, or can be automatically generated.

The merged display 402 further includes a display of the metadata 314 when the user 120 of FIG. 1 selects one of the images 304. The merged display 402 is further depicted showing a statistical report 408 for the time period when the images 304 were captured by the camera modules 102 of FIG. 1.

The statistical report 408 can be the results of statistical operations on the metadata 314 collected during the capture of the images 304 by the camera modules 102. The statistical report 408 are contemplated to include whole series, average readings, peak readings, peak to trough readings, or a combination thereof of the metadata 314. The statistical report 408 can further include comparisons with previously collected metadata 314.

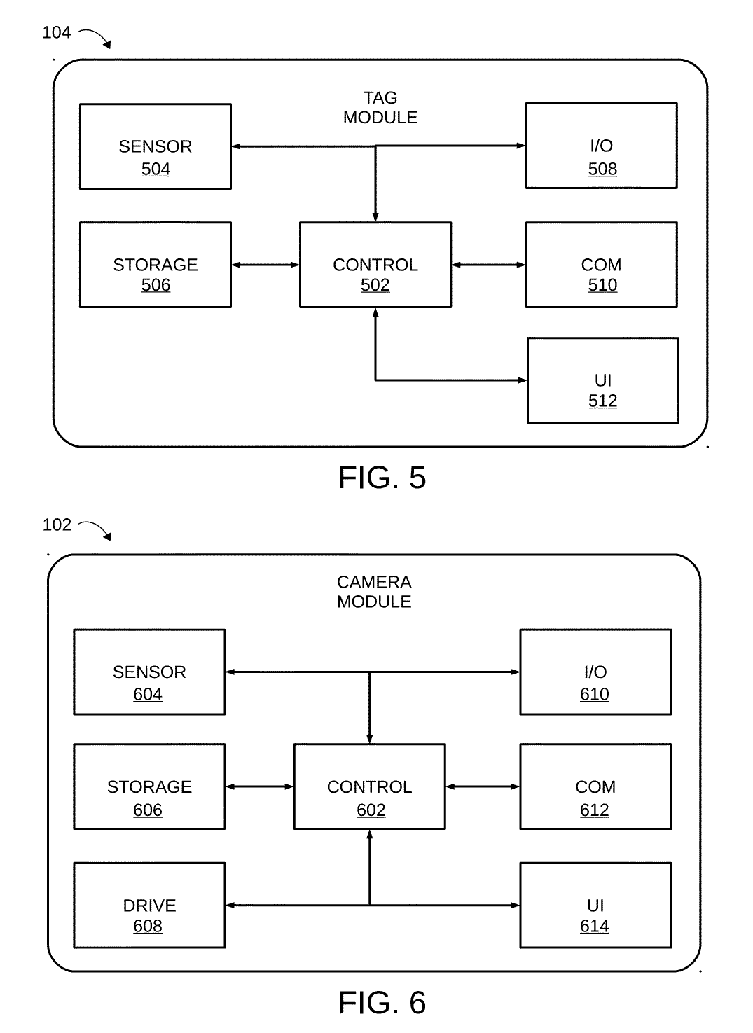

Referring now to FIG. 5, therein is shown a block diagram of the tag 104 of FIG. 1. The block diagram represents and shows structural components of the tag 104. The tag 104 is depicted to include a control block 502 coupled to a sensor block 504, a storage block 506, an I/O block 508, a communication block 510, and a user interface block 512.

The control block 502 can be implemented in a number of different manners. For example, the control block 502 can be a processor, an embedded processor, a microprocessor, a hardware control logic, a hardware finite state machine, a digital signal processor, or a combination thereof.

The sensor block 504 can include a nine degree of freedom inertial measurement unit. The inertial measurement unit can include accelerometers, gyroscopes, and magnetometers. Each of the accelerometers, gyroscopes, and magnetometers can be multiple axis or triple axis accelerometers, gyroscopes, and magnetometers.

The sensor block 504 can further include barometric pressure sensors. The sensors can provide information to the control block 502 such as directional information, acceleration information, pressure information, and orientation information. The sensor block 504 of the tag 104 can also include a microphone.

The storage block 506 of the tag 104 can be a tangible computer readable medium and can be implemented as a volatile memory, a nonvolatile memory, an internal memory, an external memory, or a combination thereof. For example, the storage block 506 can be a nonvolatile storage such as random access memory, flash memory, disk storage, or a volatile storage such as static random access memory.

The storage block 506 can receive and store the information from control block 502, the sensor block 504, the I/O block 508, the communication block 510, the user interface block 512, or a combination thereof. The information stored with the storage block 506 can include information recorded by the tag 104 during the operation of the image recording system 100 of FIG. 1.

During a post synchronization step between the tag 104 and the camera modules 102 of FIG. 1, the information stored within the storage block 506 of the tag 104 can be appended to the images 304 of FIG. 3 captured by the camera modules 102 as the metadata 314 of FIG. 3. The metadata 314 can include acceleration, velocity, heart rate, and rotation information. The metadata 314 can be time stamped to synchronize the metadata 314 with the images 304 based on when the metadata 314 and images 304 were recorded.

Audio record by the microphone of the sensor block 504 can include audio that the user 120 wearing the tag 104 hears or any speech from the user 120 during use of the image recording system 100. The audio can also be appended to the images 304 captured by the camera modules 102 during the post synchronization step. In non-sports implementations of the image recording system 100, the tag 104 microphone can be used to capture, record or transmit a lecture, speech, instructional video, or performance. It is also contemplated that the microphone can record when the camera modules 102 are not recording or can be configured to record based on the camera modules 102 recording.

It is contemplated that the control block 502 could process the metadata 314 captured by the sensor block 504 of the tag 104 and provide the statistical report 408 of FIG. 4 based on the metadata 314. It is contemplated that the metadata 314 appended to the images 304 captured by the camera modules 102 can include traditional metrics like vertical footage and maximum speed and a less traditional metrics like total “Airtime” or angular velocity. The storage block 506 can further store software or applications for use with the image recording system 100.

The I/O block 508 can include direct connection and wireless input and output capabilities. It is contemplated that the I/O block 508 can be implemented with various USB configurations, Firewire, eSATA, Thunderbolt, or other physical connections. It is contemplated that the I/O block 508 can be implemented with wireless connections such as Bluetooth, IrDA, WUSB, or other wireless configurations.

The I/O block 508 is contemplated to be used for data transfer over short distances such as transferring the recordings of the microphone and the metadata 314 from the tag 104 to the camera modules 102. The communication block 510 of the tag 104 can include an RF transceiver for communicating specifically with the camera modules 102 at distances greater than the I/O block 508.

The communication block 510 is contemplated to include the antennas 112 of FIG. 1. In some contemplated embodiments the antennas 112 can function as a lanyard for the user. It has been discovered that the tag 104 can be generally small and light enabling the user 120 to wear the tag 104 anywhere on their person.

Referring now to FIG. 6, therein is shown a block diagram of the camera modules 102 of FIG. 1. The block diagram represents and shows structural components of the camera modules 102. The camera modules 102 are depicted to include a control block 602 coupled to a sensor block 604, a storage block 606, a drive block 608, an I/O block 610, a communication block 612, and a user interface block 614.

The control block 602 can be implemented in a number of different manners. For example, the control block 602 can be a processor, an embedded processor, a microprocessor, a hardware control logic, a hardware finite state machine, a digital signal processor, or a combination thereof.

The sensor block 604 can include a nine degree of freedom inertial measurement unit. The inertial measurement unit can include accelerometers, gyroscopes, and magnetometers. Each of the accelerometers, gyroscopes, and magnetometers can be multiple axis or triple axis accelerometers, gyroscopes, and magnetometers.

The sensor block 604 can further include barometric pressure sensors. The sensors can provide information to the control block 602 such as directional information, acceleration information, pressure information, and orientation information.

The sensor block 604 of the camera modules 102 further includes image sensors. The image sensors can be charge-coupled devices or metal-oxide-semiconductor devices. The image sensors can be configured to capture the images 304 of FIG. 3.

It is contemplated that the sensor block 604 of the camera modules 102 can include multiple image sensors configured to capture the images 304. For example, the sensor block 604 can include separate and independent image sensors for the motion videos 306 of FIG. 3, the burst sequence images 308 of FIG. 3, the burst images 310 of FIG. 3, and the still images 312 of FIG. 3.

It has been discovered that including multiple image sensors for different types of the images 304 can improve the quality of the images 304 captured. The sensor block 604 of the camera modules 102 are further contemplated to include optical sensors such as range finders or light sensors for calibrating the image sensors and adjusting an iris opening.

The storage block 606 of the camera modules 102 can be a tangible computer readable medium and can be implemented as a volatile memory, a nonvolatile memory, an internal memory, an external memory, or a combination thereof. For example, the storage block 606 can be a nonvolatile storage such as random access memory, flash memory, disk storage, or a volatile storage such as static random access memory.

The storage block 606 can receive and store the information from control block 602, the sensor block 604, the I/O block 610, the communication block 612, the user interface block 614, or a combination thereof. The storage block 606 of the camera modules 102 can further be used to receive and store information from the tag 104 of FIG. 1.

The information stored with the storage block 606 can include information recorded by the tag 104 during the operation of the image recording system 100 of FIG. 1. The storage block 606 can record the information from the tag 104 upon a synchronization step after the image recording system 100 is used to capture the images 304.

As an illustrative example, the information stored by the storage block 606 can include the metadata 314 of FIG. 3 captured by the tag 104 and camera modules 102 that can be saved and appended to the images 304 captured with the optical sensor block 604. It is contemplated that the metadata 314 can be stored as series of raw sampled data or that the data can be analyzed or filtered, for example by providing and storing an average velocity or a peak velocity, respectively within the statistical report 408 of FIG. 4.

The storage block 606 can further store software or applications for use with the image recording system 100. The drive block 608 can include drive motors, gearing, or control units for adjusting the position portions of the camera modules 102 including the position and direction of image sensors and optics. It is contemplated that the image sensors or the optics can be in direct contact with components of the drive block 608.

The I/O block 610 can include direct connection and wireless input and output capabilities. It is contemplated that the I/O block 610 can be implemented with various USB configurations, Firewire, eSATA, Thunderbolt, or other physical connections. It is contemplated that the I/O block 610 can be implemented with wireless connections such as Bluetooth, IrDA, WUSB, or other wireless configurations.

Additionally, in one contemplated embodiment, the I/O block 610 can be used to interface with the eyeglass viewfinder 126 of FIG. 1. The I/O block 610 is contemplated to be used for data transfer over short distances such as recordings from the microphone or the metadata 314 of the tag 104 or uploading the images 304 to another computing system such as the user device 206 of FIG. 2.

The communication block 612 of the camera modules 102 can include an RF transceiver for communicating with the communication block 510 of FIG. 5 of the tag 104 when determining the location of the tag 104 relative to the camera modules 102. The communication block 612 is contemplated to include the antennas 112 of FIG. 1, which can be mounted and configured with a fixed distance apart.

The camera modules 102 can track and target the tag 104 using various methods and inputs from the sensor block 604, the communication block 612, or a combination thereof. One method of determining the location of the tag 104 in relation to the camera modules 102 can be a real time tracking using time-of-flight two way ranging.

Time-of-flight two way ranging technology can provide the distance 124 of FIG. 1 and angle of origination, on a plane defined by the X-axis 114 of FIG. 1 and the Y-axis 116 of FIG. 1, for the antennas 112 of the tag 104 relative to the antennas 112 of the camera modules 102. As an illustrative example, time stamps can be used to determine the time it takes for the RF signal to travel between the antennas 112 of the tag 104 and the antennas 112 of the camera modules 102. The time of flight can be used to calculate the distance 124.

Each of the antennas 112 on the camera modules 102 will have a separate distance calculation because the antennas 112 are at different locations on the camera modules 102. The antennas 112 of the camera modules 102 being a known fixed distance apart when combined with the distance from each of the antennas 112 of the camera modules 102 to tag 104 can be used to triangulate a location of the tag 104 along the X-axis 114 and Y-axis 116.

It is contemplated that the location of the tag 104 along the Z-axis 118 of FIG. 1 can be calculated in various ways. In one method, the location of the tag 104 along the Z-axis is calculated in the control block 602 by calculating the difference in barometric pressure readings from barometric sensors in the sensor block 604 of the camera modules 102 and from barometric sensors in the sensor block 504 of FIG. 5 of the tag 104.

The difference in barometric pressure can correlate to an altitude difference, which can be used to determine the position of the tag 104 along the vertical or the Z-axis 118. Another contemplated method for determining the location of the tag 104 along the Z-axis 118 is to implement one of the antennas 112 offset from the other antennas 112 in the Z-axis 118.

The control block 602 can use the location of the tag 104 in relation to the camera modules 102 to determine an optimal focus, zoom, pan angle, and tilt angle needed to maintain the placement 212 of FIG. 2 of the tag 104 within the frame 122 of FIG. 1. The control block 602 can compare the optimal focus, zoom, pan angle, and tilt angle with the current focus, zoom, pan angle, and tilt angle and calculate the amount of adjustment needed for the position and direction of image sensors and optics to be in the optimal focus, zoom, pan angle, and tilt angle to maintain the placement 212 of the tag 104 within the frame 122.

If the position and direction of image sensors and optics do not provide the required placement 212 of the tag 104 within the frame 122, the control block 602 can send an adjustment command to the drive block 608 to adjust the camera modules 102. If the zoom is too large or small to maintain the height 210 of FIG. 2 of the frame 122 selected by the user 120 of FIG. 1, the control block 602 can send an adjustment command to the drive block 608 to adjust optics for the zoom. If the focus is too close or far to maintain a sharp image, the control block 602 can send an adjustment command to the drive block 608 to adjust optics for the focus.

The communication block 612 of the camera modules 102 can further receive information from the sensor block 504 of the tag 104 including information from the gyroscope, the accelerometer, the barometric pressure meter, and the magnetometer. The information from the sensor block 504 of the tag 104 can alert the camera modules 102 when a rapid or sharp movement or acceleration occurs in the tag 104.

If the sensor block 504 of the tag 104 does alert the camera modules 102 to a sudden movement or acceleration, the control block 602 of the camera modules 102 can use the information from the sensor block 504 of the tag 104 to predict where the tag 104 is moving and send adjustment commands to the drive block 608 to make adjustments to the position and direction of image sensors and optics before the location along the X-axis 114, the Y-axis 116, or the Z-axis 118 are calculated using the time-of-flight or angle of arrival methods.

When the control block 602 of the camera modules 102 calculates how much adjustment is required for the drive block 608 to adjust the position and direction of image sensors or optics in order to maintain proper placement 212, height 210, and focus, the control block 602 can incorporate and modify the adjustments needed and sent to the drive block 608 based on information provided by the sensor block 604 of the camera modules 102. In addition, the information from the sensor block 604 of the camera modules 102 can be used to compensate for tilt, rotation, or sideways motion of the camera modules 102 themselves.

Another method that can be employed to calculate the position of the tag 104 in relation to the camera modules 102 is time difference of arrival. The time difference of arrival method can be used individually or to supplement the time-of-flight two way ranging method in determining the location of the tag 104 along the X-axis 114, the Y-axis 116, or the Z-axis 118.

The time difference of arrival can provide a faster sample rate with less power usage. The time difference of arrival method can be implemented when the antennas 112 in the camera modules 102 are a known distance apart and are both physically wired together so they can be synchronized to a common clock.

The difference in time between the receipt of the RF signal from the tag 104 by the antennas 112 can be used to determine the angle of where the RF signal originated, which can be used to calculate the pan angle or tilt angle of the camera modules 102. Another method that can be used to determine the location of the tag 104 in relation to the camera modules 102 is an angle of arrival scheme.

Angle of arrival scheme can also be used to determine the angle of origination for the RF signal from the tag 104. The angle of arrival scheme can use the antennas 112 arranged as an array of multiple antennas. The angle of arrival scheme can calculate the camera pan angle similarly to the time difference of arrival scheme except the difference in phase of the received RF signal is used to determine the angle of origination.

The antennas 112 can be modeled as two antenna arrays a fixed distance apart. An angle that the RF signal arrives on each of the anchor antennas can be used to estimate the relative location of the tag 104 to the camera modules 102 along the X-axis 114, Y-axis 116, or the Z-axis 118.

Further computer vision can be implemented to determine the location of the tag 104 relative to the camera modules 102 can be determined by recognizing the tag 104 with the image sensor of the sensor block 604. It is contemplated that the camera modules 102 would first determine the distance 124 between the camera modules 102 and the tag 104 using a time of flight scheme or using an optical range finder contained within the sensor block 604.

Once the camera modules 102 determine the distance 124 to the tag 104, the camera modules 102 can scan the frame 122 for the tag 104 in the form and size of an expected symbol. The form of the symbol can be a shape and color for easy recognition by computer vision such as a trapezoid of a solid color.

For example, if the symbol is a red trapezoid, the camera modules 102 viewing the symbol will be able to determine the orientation and the direction of the symbol. For descriptive clarity determining the location of the tag 104 using the symbol and computer vision is based on receiving a signal from the tag 104 with the camera modules 102 because it would be understood by those having ordinary skill in the art that light reflecting from the symbol captured by the image sensors of the sensor block 604 or an initial ranging signal would be the basis for determining the location of the tag 104 relative to the camera modules 102.

The camera modules 102 can further include a user interface block 614. The user interface block 614 can include the display 204 of FIG. 2, speakers, a keypad, a touchpad, soft-keys, a button, a microphone, or any combination thereof to provide data and communication inputs and outputs from and to the user 120. In one contemplated embodiment, the user interface block 614 can include a small screen, two or more buttons and two or more indicator lights. In other contemplated embodiments, the screen could be larger and also act as a viewfinder.

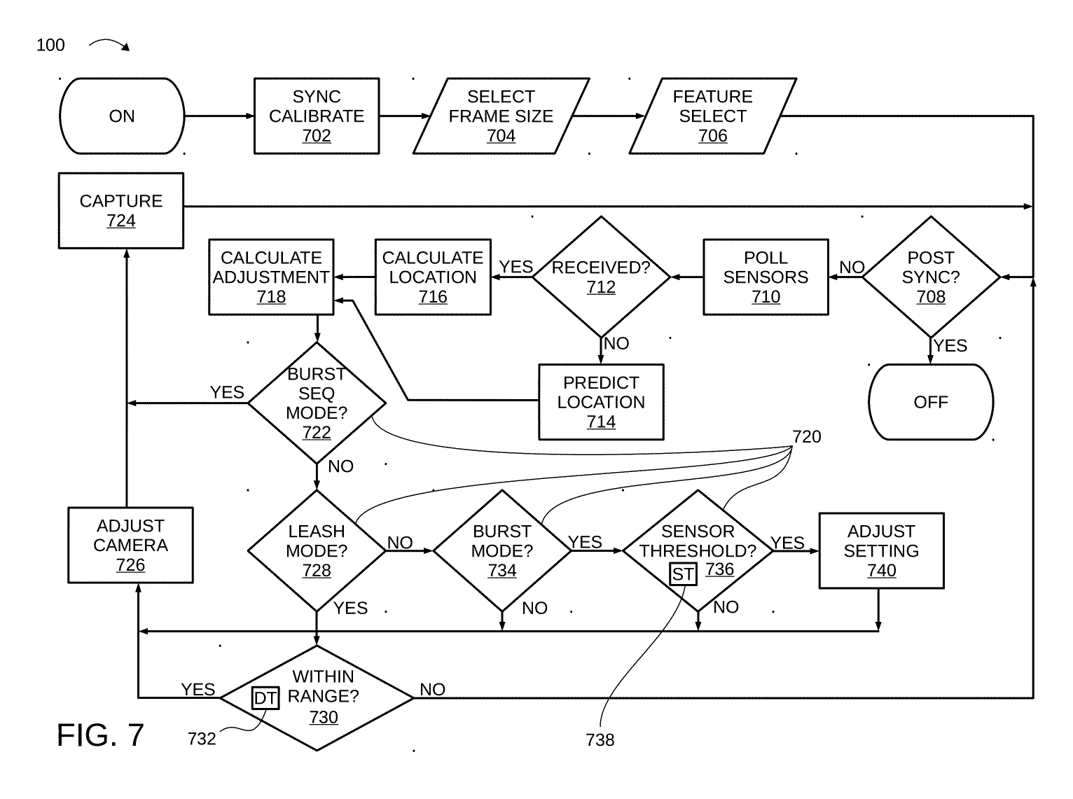

Referring now to FIG. 7, therein is shown a control flow for the image recording system 100 of FIG. 1. The image recording system 100 is shown having a synchronizing step 702 once the image recording system 100 is turned on.

The synchronizing step 702 can include a calibration of the camera modules 102 of FIG. 1 and the tags 104 of FIG. 1 in which they are physically touching. The synchronizing step 702 can calibrate the individual sensors of the sensor block 504 of FIG. 5 in the tag 104 and in the sensor block 604 of FIG. 6 in the camera modules 102. In addition, it is contemplated that sensors such as the barometric pressure readers of the sensor block 504 for the tag 104 and in the sensor block 604 for the camera modules 102 can be calibrated to provide identical altitude readings when they are touching and at the same altitude.

Further, it is contemplated that the pan, tilt, and distance can be calibrated to ensure the tag 104 has the proper placement 212 of FIG. 2 within the frame 122 of FIG. 1 and the proper height 210 of FIG. 2 within the frame 122 as well as ensuring that focus is accurate. The pan and tilt could be calibrated by using a viewfinder on the camera modules 102 or by streaming a preview to the user device 206 of FIG. 2 while the distance could be calibrated by positioning the tag 104 a known distance 124 of FIG. 1 from the camera modules 102 during the synchronizing step 702.

The image recording system 100 can further include two user input steps: a frame selection step 704 and a feature selection step 706. The frame selection step 704 can allow the user 120 of FIG. 1 to choose the height 210 and placement 212 of the frame 122 as described above with regard to FIG. 2.

For example, the options of the frame selection step might include a selection for a six foot, twelve foot, an eighteen foot, or a custom height 210 of the frame 122 around the tag 104. The camera modules 102 can dynamically adjust a zoom with the optics of the camera modules 102 to keep the height 210 of the frame 122 constant while tracking the tag 104.

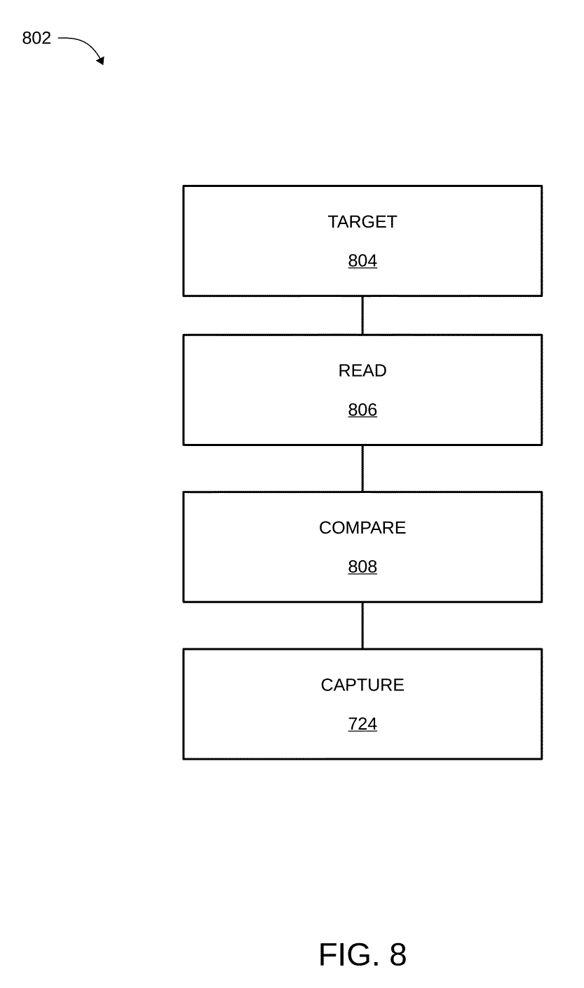

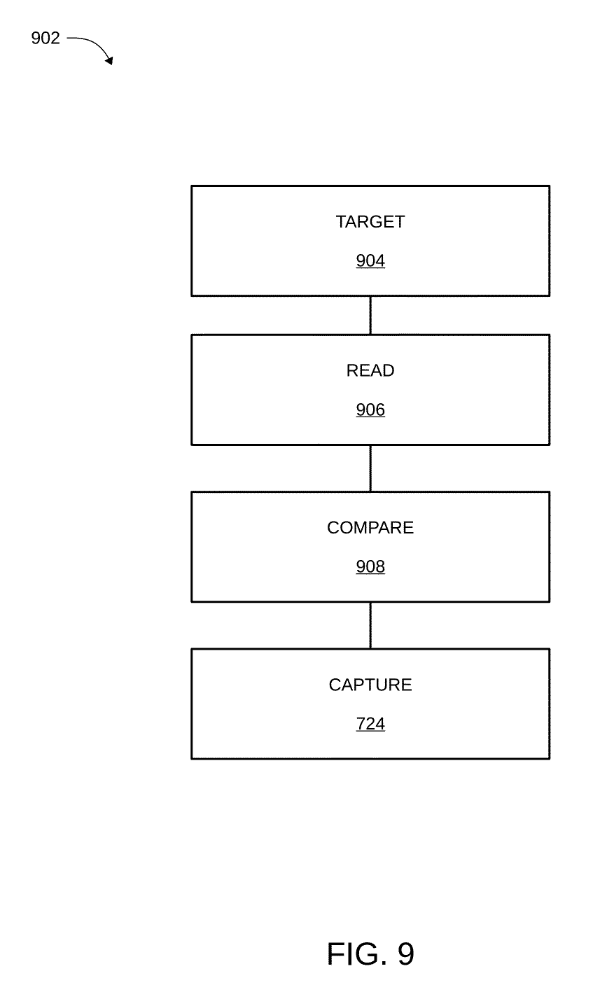

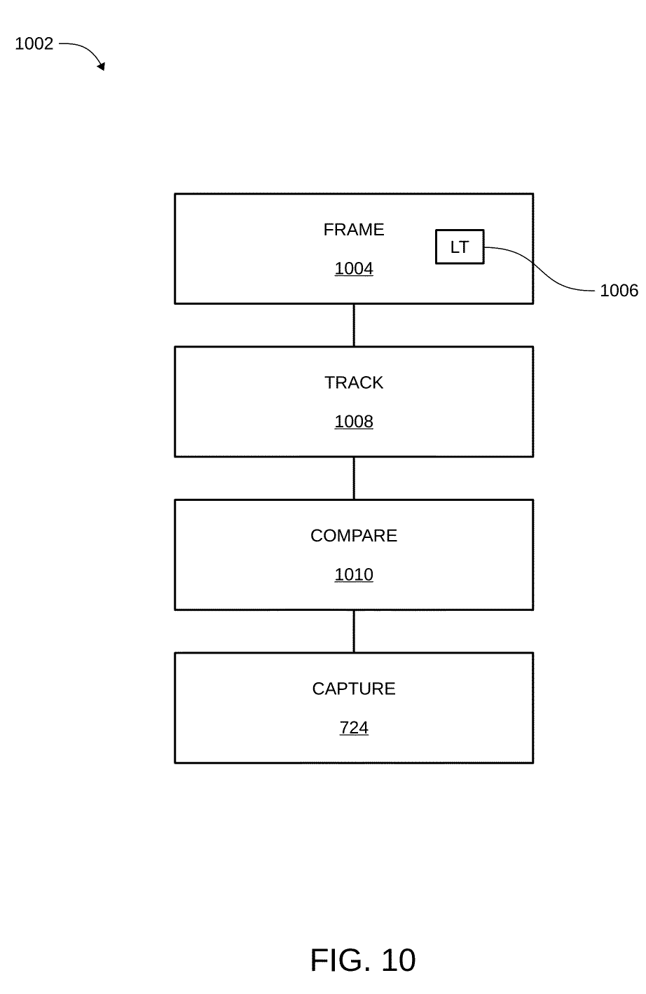

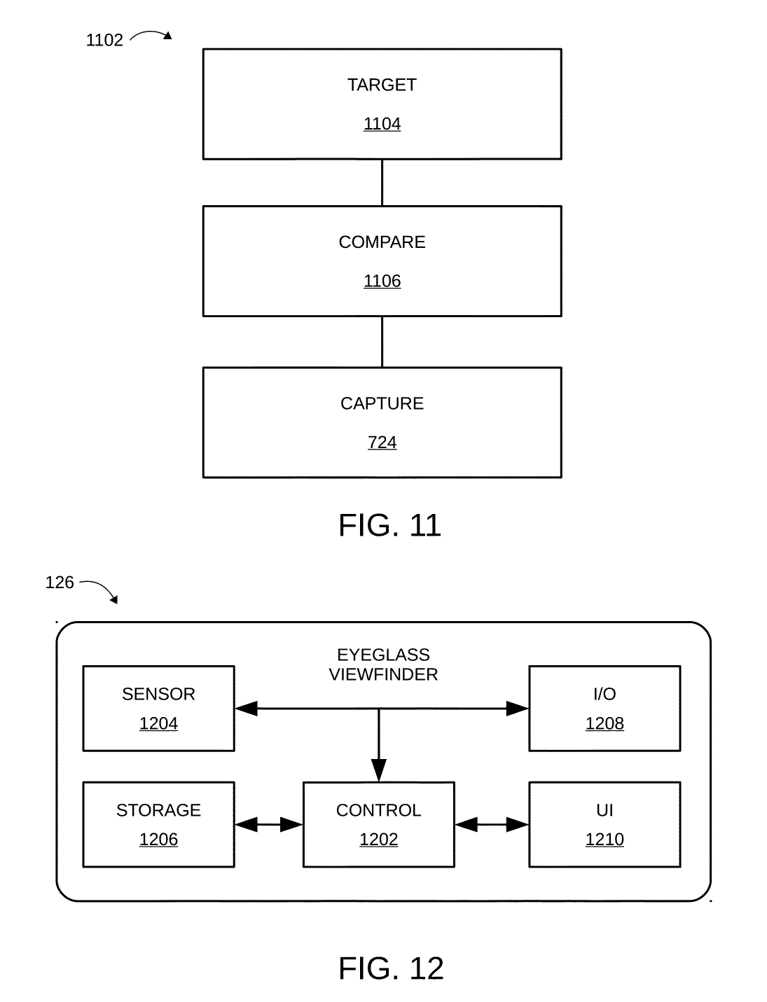

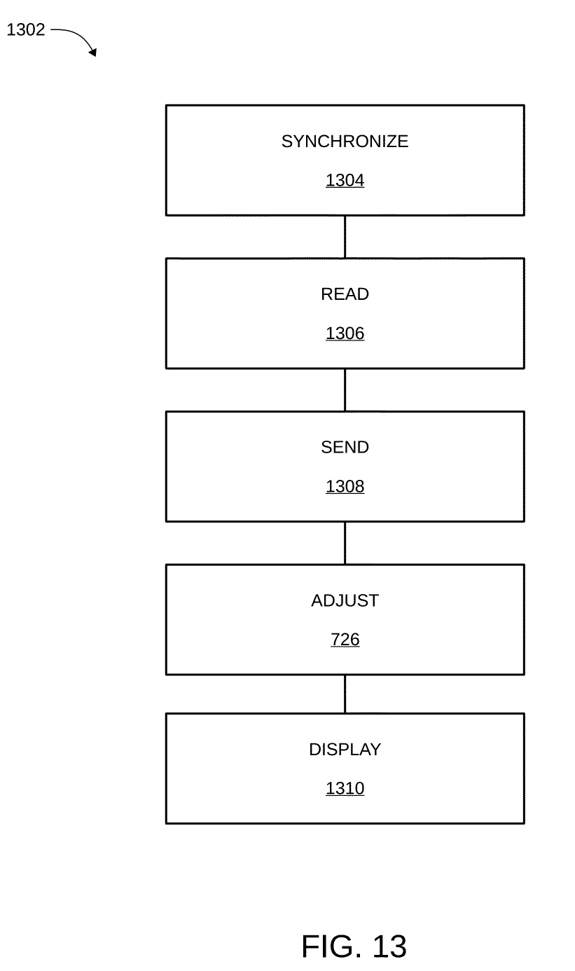

The feature selection step 706 can provide the option to configure the camera modules 102 to employ various methods of capturing the images 304 of FIG. 3. Illustratively, the users 120 can choose to select the burst mode 802 of FIG. 8 for capturing the burst images 310 of FIG. 3, the video mode 902 of FIG. 9 for capturing the motion videos 306 of FIG. 3, the burst sequence mode 1002 of FIG. 10 for capturing the burst sequence images 308 of FIG. 3, the leash mode 1102 of FIG. 11 for capturing any of the images 304, and the eyeglass viewfinder mode 1302 of FIG. 13 for capturing any of the images 304.

A post synchronization decision step 708 can be implemented by the image recording system 100 to determine whether the camera modules 102 and the tag 104 have engaged in a post synchronization step. If the post synchronization step has begun then the image recording system 100 can conclude the tracking and capturing operations of the camera modules 102 of the image recording system 100.

If the post synchronization step has not been initiated, the camera modules 102 can poll the communication block 612 of FIG. 6 in a poll sensor step 710. The poll sensor step 710 can determine whether any signals have been received by the camera modules 102 from the tags 104. A signal reception decision block 712 can be initiated once the poll sensor step 710 has returned results.

If no signals have been received by the communication block 612 of the camera modules 102, or if the signals have been received but have been distorted in some way, then the signal reception decision block 712 can initiate a predict location step 714. The predict location step 714 can utilize the control block 602 of FIG. 6 for the camera modules 102 to estimate the location and trajectory of the tag 104.

The predict location step 714 can utilize the last known position of the tag 104, last known trajectory of the tag 104, and in the case where the RF signal is received and read but the ranging results are distorted, the inputs from the sensor block 504 on the tag 104 to predict the location of the tag 104 relative to the camera modules 102. The predict location step 714 can further utilize any change in location of the camera modules 102 detected by the sensor block 604 of the camera modules 102 to predict the location of the tag 104 relative to the camera modules 102.

It is further contemplated that the prediction of the tag's 104 location or movement could be used in conjunction with the reception of the RF signal. If the communication block 612 of the camera modules 102 does receive a signal from the tag 104, the control block 602 of the camera modules 102 can calculate the relative location between the tag 104 and the camera modules 102 without requiring the location to be predicted in the predict location step 714. The location of the tag 104 relative to the camera modules 102 can be calculated in a calculate location step 716 by using one of the methods of determining the location of the tag 104 in relation to the camera modules 102 described above with regard to FIG. 6.

After the control block 602 of the camera modules 102 determines or predicts the location of the tag 104 in relation to the camera modules 102, a calculate adjustment step 718 can be invoked by the control block 602 of the camera modules 102 to calculate an adjustment needed for the optics, and image sensors to maintain the placement 212 and the height 210 of the frame 122 around the tag 104. The image recording system 100 further includes selection decision blocks 720 corresponding to the user selected features of the feature selection step 706.

For descriptive clarity the decision step corresponding to the user selected features of the feature selection step 706 will be described briefly with regard to FIG. 7 and the user selected features will be described in greater detail with regard to FIGS. 8-13. If the burst sequence mode 1002 has been selected by the user 120, a burst sequence decision step 722 can initiate a capture step 724 while bypassing an adjustment step 726.

That is, the camera modules 102 will not reposition or adjust the optics or the image sensors so that the background of the burst sequence images 308 remains unchanged. The control block 602 of the camera modules 102 can instruct the image sensors to capture a rapid succession of images in the capture step 724 without adjusting the camera modules 102 for tracking and targeting the tag 104.

A leash decision step 728 can be executed to determine whether the leash mode 1102 has been selected by the user 120. If the leash mode 1102 has been selected a leash range threshold decision step 730 can be used to determine whether the distance 124 of FIG. 1 between the tag 104 and the camera modules 102 crosses a distance threshold 732 by being closer to the camera modules 102 than the distance threshold 732. The distance threshold 732 can be a lower threshold for the distance 124 between the tag 104 and the camera modules 102, and when the distance 124 moves below the distance threshold 732 the distance threshold 732 is crossed and the control block 602 of the camera modules 102 can instruct the image sensors within the camera modules 102 to capture the images 304 in the capture step 724 or track and target the tag 104 in the adjustment step 726.

If the control block 602 of the camera modules 102 determines that the distance 124 between the tag 104 and the camera modules 102 is over a distance threshold 732, the camera modules 102 will not adjust the optics or the image sensors in the adjustment step 726. Instead if the distance 124 between the tag 104 and the camera modules 102 is larger than the distance threshold 732, the camera modules 102 will continue to monitor the tag in the poll sensor step 710, predict the location of the tag 104 relative to the camera modules 102 in the predict location step 714, and calculate location of the tag 104 relative to the camera modules 102 in the calculate location step 716.

Alternatively, if the control block 602 of the camera modules 102 determines that the distance 124 between the tag 104 and the camera modules 102 is smaller than the distance threshold 732, the camera modules 102 will adjust the optics and the image sensors in the adjustment step 726 to track and target the tag 104, and will also capture the images 304 in the capture step 724. It is contemplated that the camera modules 102 can capture the motion videos 306, the burst images 310, or the still images 312 of FIG. 3 when the distance 124 is below the distance threshold 732.

A burst mode decision step 734 can be executed to determine whether the burst mode 802 has been selected. If the burst mode 802 has been selected, a sensor threshold decision step 736 can be executed. The sensor threshold decision step 736 can be used to determine whether the sensor block 504 of the tag 104 has experienced any readings that would exceed or cross a sensor threshold 738 for beginning the burst mode 802.

It is contemplated that the sensor threshold 738 can be crossed by falling below the sensor threshold 738 or crossed by rising above the sensor threshold 738. It is further contemplated that the sensor threshold 738 could include multiple thresholds.

As an illustrative example, the sensor threshold decision 736 step could include the sensor threshold 738 of three g-forces of acceleration for the burst mode 802 to begin. If the accelerometers within the sensor block 504 of the tag 104 experience g-forces in excess of the sensor threshold 738, the sensor threshold decision step 736 will indicate that the sensor threshold 738 is crossed and the images 304 should be captured in the capture step 724.

Alternatively, the sensor threshold decision step 736 can be used to determine whether the sensor block 604 of the camera modules 102 has experienced any forces that would exceed or cross the sensor threshold 738 for beginning the burst mode 802. If the sensors within the sensor block 604 of the camera modules 102 experience forces in excess of the sensor threshold 738, the sensor threshold decision step 736 will indicate that the sensor threshold 738 has been crossed and the images 304 should be executed in the capture step 724.

Once the sensor threshold decision step 736 determines that the sensor threshold 738 is crossed for the sensors within the sensor block 504 of the tag 104 or the sensor block 604 of the camera modules 102, a capture setting adjustment step 740 can be executed. The capture setting adjustment step 740 can set flags for capture modes to be executed during the capture step 724. For example, when the user 120 selects still images 312, the burst images 310, the motion videos 306, or a combination thereof, the capture setting adjustment step 740 can set flags in the camera modules 102 for capturing the selected images 304 during the capture step 724.

It is contemplated that the camera modules 102 can be set to continuously capture the motion videos 306 in the capture step 724 in the standard frame rate video format. The capture setting adjustment step 740 can flag the camera modules 102 to increase the frame rate of the motion videos 306 when the thresholds are met for the sensors within the sensor block 504 of the tag 104 so that the camera modules 102 will capture the motion video 306 in the high frame rate video format. For example, when the sensors of the sensor block 502 detect an acceleration above the sensor threshold 738, the frame rate of the motion video 306 capture can increase from 24 to 30 frames per second when capturing the standard frame rate to 60 or 120 frames per second when capturing the high frame rate.

Once the location of the tag 104 is predicted relative to the camera modules 102, the camera modules 102 can make the requisite adjustments to track and target the tag 104 in the adjustment step 726 in order to maintain the proper placement 212 and height 210 of the frame 122. The adjustment step 726 can be executed after the distance 124 between the tag 104 and the camera modules 102 has been determined to be less than the distance threshold 732 when the leash mode 802 is selected, when the burst sequence mode 1002 has not been chosen, when the sensor threshold 738 has not been met in the sensor threshold decision step 736, or after the capture setting adjustment step 740.

It is contemplated that the adjustment step 726 can be used in conjunction with the selection decision blocks 720 for the user selected features of the feature selection step 706 when a continuous adjustment for proper placement 212 and height 210 of the frame 122 is desired, or continuous capture of the motion video 306 is desired. It is further contemplated that the burst sequence mode 1002 can disable or bypass the adjustment step 726.

It is further contemplated that the adjustment step 726 can be disabled or bypassed when the leash mode 1102 is invoked and the distance 124 between the tag 104 and the camera modules 102 is not less than the distance threshold 732. Within the adjustment step 726, the control block 602 of the camera modules 102 can send instructions to the drive block 608 of FIG. 6 to physically change the position of the optics and the image sensors to maintain the placement 212 and height 210 of the frame 122 around the tag 104.

The capture step 724 can be triggered after the adjustment step 726 to capture the images 304 using the image sensors of the camera modules 102 based on the selections made by the user 120 in the feature selection step 706. It is contemplated that the motion videos 306 can be captured with an image sensor that is designed to provide video image capture, while still images 312 can be captured with an independent image sensor.

In one contemplated embodiment, the optics of the camera modules 102 can allow the image to be split or directed to various image sensors based on the type of the images 304 captured. In the alternative, it is contemplated that each kind of the images 304 can be captured with a single image sensor.

Referring now to FIG. 8, therein is shown a control flow for a burst mode 802 for the image recording system 100 of FIG. 1. The burst mode 802 is depicted with a target step 804. The target step 804 can be engaged to track or target the tag 104 of FIG. 1 ensuring that the placement 212 of FIG. 2 and the height 210 of FIG. 2 is correct for the frame 122 of FIG. 1 around the tag 104 as well as ensuring proper focus.

When the target step 804 is engaged, the camera modules 102 of FIG. 1 can continually determine the location of the tag 104 relative to the camera modules 102 in the calculate location step 716 of FIG. 7 or predict the location of the tag 104 relative to the camera modules 102 in the predict location step 714 of FIG. 7. The location of the tag 104 relative to the camera modules 102 can be used to adjust the image sensors and the optics of the camera modules 102 in the adjustment step 726 of FIG. 7.

It is contemplated that the target step 804 can run continuously in parallel with the other steps of the burst mode 802. It is further contemplated that the target step 804 can be combined with the adjustment step 726 to maintain the placement 212 and height 210 of the frame 122 around the tag 104 within the placement 212 and height 210 selections of the user 120 of FIG. 1, and to maintain proper focus. The target step 804 can implement the targeting and tracking methods described above with regard to FIG. 6.

A read step 806 can be implemented to read communications from the communication block 612 of FIG. 6 for the camera modules 102. The communication block 612 of the camera modules 102 can receive sensor data from the sensor block 504 of FIG. 5 for the tag 104.

The communication block 612 of the camera modules 102 can be configured to collect different types of sensor data from the sensor block 504 of the tag 104. As an illustrative example, the communication block 612 can collect acceleration information from accelerometers, and orientation and angular velocity from gyroscopic sensors, both sensors located in the sensor block 504 of the tag 104.

The data from the sensors of the sensor block 504 of the tag 104 can be compared to the sensor threshold 738 of FIG. 7 in a compare step 808. As an illustrative example, the sensor threshold 738 may be acceleration thresholds including an upper limit of three times the gravitational force of earth and a lower limit of less than half of the gravitational force of the earth.

In this illustrative example, the sensor threshold 738 may detect when the user 120 with the tag 104 mounted thereto takes a high-g turn thus exceeding and crossing the upper threshold or when the user 120 with the tag 104 mounted thereto experiences a free fall thus falling below and crossing the lower threshold. A second illustrative example could include the sensor threshold 738 as a threshold for rotational speed with an additional time threshold. For example, the sensor threshold 738 could be triggered when the tag 104 experiences a rotational speed crossing above a threshold indicating a flipping, rolling, or twisting maneuver. The time threshold could be implemented to reduce false triggers.

It is contemplated the sensor threshold 738 could be selected by the user 120 or could be constructed specifically for a certain activity. As an example the sensor threshold 738 could include various gravitational force thresholds generally experienced by drivers as they enter and exit specific corners on a race track. When the tag 104 experiences these gravitational forces within upper or lower limits of the sensor threshold 738 for the corners, the control block 602 of FIG. 6 for the camera modules 102 could identify the specific corner the driver is entering or exiting.

Similarly, when a figure skater performs specific jumps with a specific number of rotations, the control block 602 of the camera modules 102 could utilize the sensor threshold 738 to identify each jump or combination. Along with triggering the burst mode 802, these sensor thresholds 738 can be used to assign the metadata 314 of FIG. 3 to the images 304 of FIG. 3 captured automatically.

Once the sensor thresholds 738 are crossed, the burst mode 802 can activate the capture step 724. The capture step 724 can be used to take a rapid burst of still photos within some pre-determined time frame with the image sensors within the sensor block 604 of FIG. 6 for the camera modules 102. Alternatively, it is contemplated that the motion videos 306 of FIG. 3 in both the standard frame rate and the high frame rate, the burst images 310 of FIG. 3, the still images 312 of FIG. 3, or a combination thereof can be captured during the capture step 724 when the sensor threshold 738 are crossed in the burst mode 802.

As an illustrative example, ten of the burst images 310 in a one second could be taken as the camera modules 102 continue to adjust the placement 212 of the frame 122, the height 210 of the frame 122, and the focus.

It is contemplated that the number of the images 304 and duration of time within which the images 304 are taken can be configured by the user 120. Alternatively, it is contemplated that the number of the images 304 and the duration of time within which the images 304 are taken can be based on the maneuver triggering the burst mode 802.

It is further contemplated that in one embodiment, the image viewed by the sensor block 604 of the camera modules 102 could be split by optics. One of the images 304 could be recorded by image sensors optimized for the motion videos 306 while the other image could be recorded by an image sensor optimized for still photography. In this way the motion videos 306 could continue to be taken as the camera modules 102 collects multiple still shots during the capture step 724.

It has been discovered that the image recording system 100 can greatly decrease the complexity and skill required to capture valuable images 304 that are difficult to capture due to their fast or momentary movements by triggering the camera modules 102 with the sensor data from the tag 104 crossing the sensor threshold 738 along with the continual tracking, targeting, zooming, and focusing.

Referring now to FIG. 9, therein is shown a control flow for a video mode 902 for the image recording system 100 of FIG. 1. The video mode 902 is depicted with a target step 904. The target step 904 can be engaged to track or target the tag 104 of FIG. 1 ensuring that the placement 212 of FIG. 2 and the height 210 of FIG. 2 is correct for the frame 122 of FIG. 1 around the tag 104 as well as ensuring proper focus.

When the target step 904 is engaged, the camera modules 102 of FIG. 1 can continually determine the location of the tag 104 relative to the camera modules 102 in the calculate location step 716 of FIG. 7 or predict the location of the tag 104 relative to the camera modules 102 in the predict location step 714 of FIG. 7. The location of the tag 104 relative to the camera modules 102 can be used to adjust the image sensors and the optics of the camera modules 102 in the adjustment step 726 of FIG. 7.

It is contemplated that the target step 904 can run continuously in parallel with the other steps of the video mode 902. It is further contemplated that the target step 904 can be combined with adjustment step 726 of FIG. 7 to maintain the placement 212 and height 210 of the frame 122 around the tag 104 within the placement 212 and height 210 selections of the user 120 of FIG. 1, and to maintain proper focus. The target step 904 can implement the targeting and tracking methods described above with regard to FIG. 6.

A read step 906 can be implemented to read communications from the communication block 612 of FIG. 6 for the camera modules 102. The communication block 612 of the camera modules 102 can receive sensor data from the sensor block 504 of FIG. 5 for the tag 104.

The communication block 612 of the camera modules 102 can be configured to collect different types of sensor data from the sensor block 504 of the tag 104. As an illustrative example, the communication block 612 can collect acceleration information from accelerometers, and orientation and angular velocity from gyroscopic sensors, both sensors located in the sensor block 504 of the tag 104.

The data from the sensors of the sensor block 504 of the tag 104 can be compared to the sensor threshold 738 of FIG. 7. As an illustrative example, the sensor threshold 738 may be acceleration thresholds including an upper limit of three times the gravitational force of earth and a lower limit of less than half of the gravitational force of the earth.

In this illustrative example, the sensor threshold 738 may detect when the user 120 with the tag 104 mounted thereto takes a high-g turn thus exceeding and crossing the upper threshold or when the user 120 with the tag 104 mounted thereto experiences a free fall thus falling below and crossing the lower threshold. A second illustrative example could include the sensor threshold 738 as a threshold for rotational speed with an additional time threshold. For example, the sensor threshold 738 could be triggered when the tag 104 experiences a rotational speed crossing above a threshold indicating a flipping, rolling, or twisting maneuver. The time threshold could be implemented to reduce false triggers.

It is contemplated the sensor threshold 738 could be selected by the user 120 or could be constructed specifically for a certain activity. As an example the sensor threshold 738 could include various gravitational force thresholds generally experienced by drivers as they enter and exit specific corners on a race track. When the tag 104 experiences these gravitational forces within upper or lower limits of the sensor threshold 738 for the corners, the control block 602 of FIG. 6 for the camera modules 102 could identify the specific corner the driver is entering or exiting.

Similarly, when a figure skater performs specific jumps with a specific number of rotations, the control block 602 of the camera modules 102 could utilize the sensor threshold 738 to identify each jump or combination. Along with triggering the video mode 902, these sensor thresholds 738 can be used to assign the metadata 314 of FIG. 3 to the images 304 of FIG. 3 captured automatically.

Once the sensor thresholds 738 are crossed, the video mode 902 can activate the capture step 724. The capture step 724 can be used to capture and record video to long-term storage in the storage block 606 of FIG. 6 for the camera modules 102. It is contemplated that the video mode 902 could continually be recording short segments of the motion videos 306 of FIG. 3 from the image sensors of the sensor block 604 of FIG. 6 and storing these motion videos 306 in short term memory. Once the sensor threshold 738 of the compare step 908 are crossed, the camera modules 102 can shift the short segment of the motion videos 306 in short-term memory to long-term storage in the storage block 606 and continue to append the motion videos 306, captured live, to the motion videos 306 stored in the long-term memory.

Alternatively, it is contemplated that the video mode 902 could continually be recording the motion videos 306 at a standard frame rate from the image sensors of the sensor block 604 and storing these motion videos 306 in long-term memory. Once the sensor threshold 738 of the compare step 908 are crossed, the camera modules 102 can capture a user defined or activity defined amount of the motion videos 306 at a high frame rate and record the high frame rate motion videos 306 to long-term storage in the storage block 606.

It is contemplated that the length of the motion videos 306 both before and after the sensor threshold 738 of the compare step 908 has been crossed could be configured by the user 120. Alternatively, it is contemplated that the length of motion videos 306 both before and after the sensor threshold 738 of the compare step 908 has been crossed can be based on the maneuver triggering the video mode 902.

It has been discovered that the image recording system 100 can greatly reduce the amount of storage, battery, and editing time required by triggering the camera modules 102 to record the motion video 306 based on sensor data from the tag 104 crossing the sensor threshold 738. It has been discovered that these benefits of the video mode 902 are even more important when working with high frame rate video as more frames are generated.

Referring now to FIG. 10, therein is shown a control flow for a burst sequence mode 1002 for the image recording system 100 of FIG. 1. The burst sequence mode 1002 is depicted with a framing step 1004 wherein the camera modules 102 of FIG. 1, the optics, image sensors, or a combination thereof is positioned to frame a static location.

That is, the framing step 1004 can be performed by the user 120 of FIG. 1 to ensure that the placement 212 of FIG. 2 and the height 210 of FIG. 2 is correct for the frame 122 of FIG. 1 around the tag 104 as well as ensuring proper focus during the burst sequence images 308 of FIG. 3. It is contemplated that the user 120 could perform the framing step 1004 by looking through a viewfinder on the camera modules 102 to frame the background.

The framing step 1004 could also include the additional step of placing the user 120 wearing the tag 104 within the frame 122. The location the user 120 wearing the tag 104 relative to the camera modules 102 can be used to set location thresholds 1006 for initiating the capture of the burst sequence images 308.

The burst sequence mode 1002 is depicted with a tracking step 1008. The tracking step 1008 can be engaged to track the tag 104. When the tracking step 1008 is engaged, the camera modules 102 can continually determine the location of the tag 104 relative to the camera modules 102 in the calculate location step 716 of FIG. 7 or predict the location of the tag 104 relative to the camera modules 102 in the predict location step 714 of FIG. 7. The location of the tag 104 relative to the camera modules 102 is not used to adjust the image sensors and the optics of the camera modules 102 in the adjustment step 726 of FIG. 7.

Instead, the optics and the image sensors of the camera modules 102 can be locked into position to maintain the frame 122 that was determined in the framing step 1004. It is contemplated that the tracking step 1008 can run continuously in parallel with the other steps of the burst sequence mode 1002. The tracking step 1008 can implement the targeting and tracking methods described above with regard to FIG. 6.

In an alternative embodiment, it is contemplated that the location thresholds 1006 around a location of the tag 104 can be set in a location setting step. The location thresholds 1006 could include a minimum and maximum distance between the camera modules 102 and the tag 104 as well as a minimum and maximum distance along the X-axis 114 of FIG. 1 on either side of the location where the tag 104 is selected. Alternatively, the location threshold 1006 could be a 3D radius around the location where the tag 104 is selected and the location threshold 1006 would be crossed once the tag 104 moved within the radius.

Illustratively, in the location setting step, the display 204 of FIG. 2 of the user device 206 can display a map of the relative positions of the camera modules 102 and the tags 104 as is depicted in FIG. 1. The user 120 could then select one of the tags 104 when the tag 104 is in the location that capturing the images 304 is desired.

The user 120 could select the tag 104 and then could draw a circle around the tag 104 indicating a size or perimeter of the location threshold 1006 or alternatively select a button for a pre-set radius around the tag 104 to use as the location threshold 1006. It is further contemplated that the location threshold 1006 could be drawn or selected at any point on the map using the locations of the camera modules 102 and the tags 104 as reference points. A measurement of distance along the sides of the display 204 can be shown for aiding the users 120 in determining, placing, and sizing the location threshold 1006.

It is contemplated that when the location threshold 1006 is determined by the location of a selected tag 104 in the location setting step, the tracking step 1008 could track and predict the location of the tag 104 relative to the camera modules 102 and then adjust the camera modules 102 to provide the proper height 210 and placement 212 of FIG. 2 of the user 120 within the frame 122 by engaging the adjustment step 726. The camera modules 102 could then capture any of the images 304, including the motion videos 306, once the location threshold 1006 is crossed.

A compare step 1010 can be executed to compare the location of the tag 104 relative to the camera modules 102 to the location thresholds 1006 identified with the camera modules 102 in the framing step 1004. It is contemplated that location thresholds 1006 can be set for the compare step 1010 to compare with the location of the tag 104 determined in the tracking step 1008 and can be a threshold for the location of the tag 104 relative to the frame.

Once the location of the tag 104 relative to the camera modules 102 is within a predefined range of the location thresholds 1006, the compare step 1010 can trigger the capture step 724. For example the predefined range of the location thresholds 1006 could be set as the location of the tag 104 relative to the camera modules 102 when the tag 104 is at the edges of the frame 122. Alternatively, the predefined thresholds of the location thresholds 1006 could be set to a pre-determined distance of the tag 104 from the edges of the frame 122.

The predefined thresholds of the location thresholds 1006 could include upper and lower thresholds for each horizontal or vertical side of the frame 122. Once the predefined thresholds of the location thresholds 1006 are crossed, the burst sequence mode 1002 can activate the capture step 724.

The capture step 724 can be used to take a rapid burst of the burst sequence images 308 while the location of the tag 104 relative to the camera modules 102 is still determined within the tracking step 1008 to be within the predefined range of the location thresholds 1006. The frequency of burst sequence images 308 can also be determined by the user 120, such as eight or ten shots per second.

It is contemplated that the control block 602 of FIG. 6 for the camera modules 102 could combine the burst sequence images 308 captured during the capture step 724 of the burst sequence mode 1002 into one sequence eliminating the need for external software or editing. It has been discovered that the image recording system 100 can greatly decrease the complexity and skill required to capture valuable burst sequence images 308 that are difficult to capture due to their fast or momentary movements by triggering the camera modules 102 with the sensor data from the tag 104.

Referring now to FIG. 11, therein is shown a control flow for a leash mode 1102 for the image recording system 100 of FIG. 1. It is contemplated that the leash mode 1102 can include preliminary steps of affixing the camera modules 102 of FIG. 1 in a desirable location. The leash mode 1102 is depicted with a target step 1104. The target step 1104 can be engaged to track or target the tag 104 of FIG. 1 ensuring that the placement 212 of FIG. 2 and the height 210 of FIG. 2 is correct for the frame 122 of FIG. 1 around the tag 104 as well as ensuring proper focus.

When the target step 1104 is engaged, the camera modules 102 can continually determine the location of the tag 104 relative to the camera modules 102 in the calculate location step 716 of FIG. 7 or predict the location of the tag 104 relative to the camera modules 102 in the predict location step 714 of FIG. 7. The location of the tag 104 relative to the camera modules 102 can be used to adjust the image sensors and the optics of the camera modules 102 in the adjustment step 726 of FIG. 7.

It is contemplated that the target step 1104 can run continuously in parallel with the other steps of the leash mode 1102. It is further contemplated that the target step 1104 can be combined with the adjustment step 726 to maintain the placement 212 and height 210 of the frame 122 around the tag 104 within the placement 212 and height 210 selections of the user 120 of FIG. 1, and to maintain proper focus. The target step 1104 can implement the targeting and tracking methods described above with regard to FIG. 6.

The leash mode 1102 can implement a compare step 1106 wherein the distance 124 of FIG. 1 between the tag 104 and the camera modules 102, calculated in the targeting step 1104, can be compared to the distance threshold 732 of FIG. 7. The distance threshold 732 can be defined by the user 120. As an illustrative example, the user 120 can set the distance threshold 732 of the camera modules 102 to fifteen feet, twenty-five feet, or fifty feet.

Once the distance 124 of the tag 104 is less than the distance threshold 732, the distance threshold 732 will be considered to be crossed and the leash mode 1102 can activate the capture step 724. The capture step 724 can be used to capture any of the images 304 of FIG. 3. The capture step 724 can be active so long as the distance threshold 732 is and remains crossed, meaning the distance 124 of the tag 104 is closer, to one of the camera modules 102 set to the leash mode 1102, than the preset distance threshold 732. It is contemplated that the burst sequence mode 1002 of FIG. 10 and the burst mode 802 of FIG. 8 can be implemented with the leash mode 1102.

It has been discovered that utilizing the distance 124 of the tag 104 from the camera modules 102 to capture the images 304 decreases the repetitiveness of capturing the images 304 greatly reducing the amount of time wasted during editing and reducing the amount of storage and battery required.

Referring now to FIG. 12, therein is shown a block diagram of the eyeglass viewfinder 126 of FIG. 1. The block diagram represents and shows structural components of the eyeglass viewfinder 126. The eyeglass viewfinder 126 is depicted to include a control block 1202 coupled to a sensor block 1204, a storage block 1206, an I/O block 1208, and a user interface block 1210.

The control block 1202 can be implemented in a number of different manners. For example, the control block 1202 can be a processor, an embedded processor, a microprocessor, a hardware control logic, a hardware finite state machine, a digital signal processor, or a combination thereof.

The sensor block 1204 can include a nine degree of freedom inertial measurement unit. The inertial measurement unit can include accelerometers, gyroscopes, and magnetometers. Each of the accelerometers, gyroscopes, and magnetometers can be multiple axis or triple axis accelerometers, gyroscopes, and magnetometers.

The sensors can provide information to the control block 1202 such as directional information, acceleration information, and orientation information. The storage block 1206 of the eyeglass viewfinder 126 can be a volatile memory, a nonvolatile memory, an internal memory, an external memory, or a combination thereof.

For example, the storage block 1206 can be a tangible computer readable medium and can be implemented as a nonvolatile storage such as random access memory, flash memory, disk storage, or a volatile storage such as static random access memory. The storage block 1206 can receive and store the information from control block 1202, the sensor block 1204, the I/O block 1208, the user interface block 1210, or a combination thereof.

The information stored with the storage block 1206 can include information recorded by the eyeglass viewfinder 126 during the operation of the image recording system 100 of FIG. 1. The storage block 1206 can further store software or applications for use with the image recording system 100.

The I/O block 1208 can include direct connection and wireless input and output capabilities. It is contemplated that the I/O block 1208 can be implemented with various USB configurations, Firewire, eSATA, Thunderbolt, or other physical connections.

It is contemplated that the I/O block 1208 can be implemented with wireless connections such as Bluetooth, IrDA, WUSB, or other wireless configurations. The I/O block 1208 is contemplated to be used for data transfer over short distances such as transferring the readings of the sensor block 1204 of the eyeglass viewfinder 126 to the camera modules 102. The user interface block 1210 can include a display such as a liquid crystal display or a head up display projection.

Referring now to FIG. 13, therein is shown a control flow for an eyeglass viewfinder mode 1302 for the image recording system 100 of FIG. 1. The eyeglass viewfinder mode 1302 can utilize the eyeglass viewfinder 126 of FIG. 1.

The eyeglass viewfinder mode 1302 can include a synchronization step 1304. During the synchronization step 1304 the eyeglass viewfinder 126 can be calibrated so that the frame 122 of FIG. 1 captured by the camera modules 102 of FIG. 1 corresponds to the direction of the eyeglass viewfinder 126 on the user 120 of FIG. 1 is facing.

That is, the images 304 of FIG. 3 captured by the camera modules 102 and displayed on the eyeglass viewfinder 126 should match what the user 120 is viewing through the eyeglass viewfinder 126. A read step 1306 can be implemented to read the sensor block 1204 of FIG. 12 of the eyeglass viewfinder 126 to determine and quantify any movement of the eyeglass viewfinder 126.

The read step 1306 can determine whether and how much the eyeglass viewfinder 126 has moved, and the direction of movement. The movement data captured during the read step 1306 from the sensor block 1204 of the eyeglass viewfinder 126 can be sent to the camera modules 102 in a send step 1308. The eyeglass viewfinder 126 can send the movement data from the I/O block 1208 of FIG. 12 for the eyeglass viewfinder 126 to the I/O block 610 of FIG. 6 for the camera modules 102.

The movement data sent from the eyeglass viewfinder 126 to the camera modules 102 can be processed by the control block 602 of FIG. 6 for the camera modules 102 and used to adjust the optics and the image sensors to maintain proper placement 212 of FIG. 2 and height 210 of FIG. 2 for the frame 122 as well as proper focus. The control block 602 of the camera modules 102 can send the required adjustments to the drive block 608 of FIG. 6 for the camera modules 102 in the adjustment step 726.

During the adjustment step 726, the drive block 608 of the camera modules 102 can reposition the optics and the image sensor to maintain synchronized movement between the camera modules 102 and the eyeglass viewfinder 126. The adjustment step 726 can ensure that what the user 120 is looking at through the eyeglass viewfinder 126 will be captured by the camera modules 102.

During a display step 1310, the camera modules 102 can send the images 304 back to the eyeglass viewfinder 126 to be displayed on the eyeglass viewfinder 126 with the user interface block 1210 of FIG. 12. It is contemplated that the display step 1310 may be optional.

For example, it is contemplated that instead of sending the images 304 to the eyeglass viewfinder 126 during the display step 1310, the user 120 could simply identify a target through a fixed structure on the eyeglass viewfinder 126. The fixed structure could exemplify the frame 122 of the camera modules 102 or simply the center of the images 304 captured by the camera modules 102 such as a cross-hair, a rectangular frame, or a targeting bead.

It has been discovered that the use of the eyeglass viewfinder 126 to direct the camera modules 102 enables users 120 to focus or capture the images 304 of multiple people, either alone or together, rather than on a single user 120 wearing the tag 104. The eyeglass viewfinder 126 can be used when the user 120 is wearing the camera modules 102, for example with a chest harness. It has further been discovered that the use of the eyeglass viewfinder 126 to direct the camera modules 102 enables users 120 to change the subject of the images 304 rather than relying solely on the tag 104 to frame the shot.

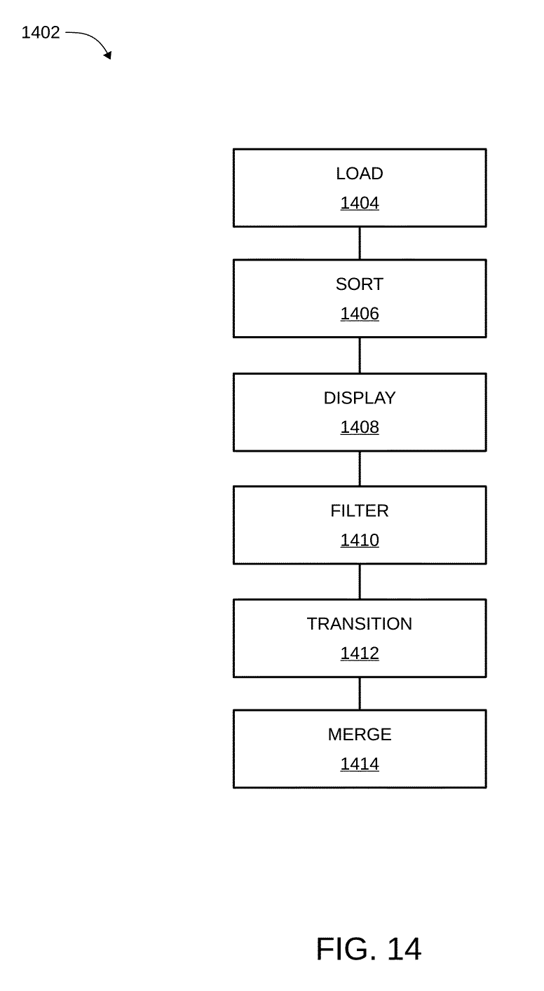

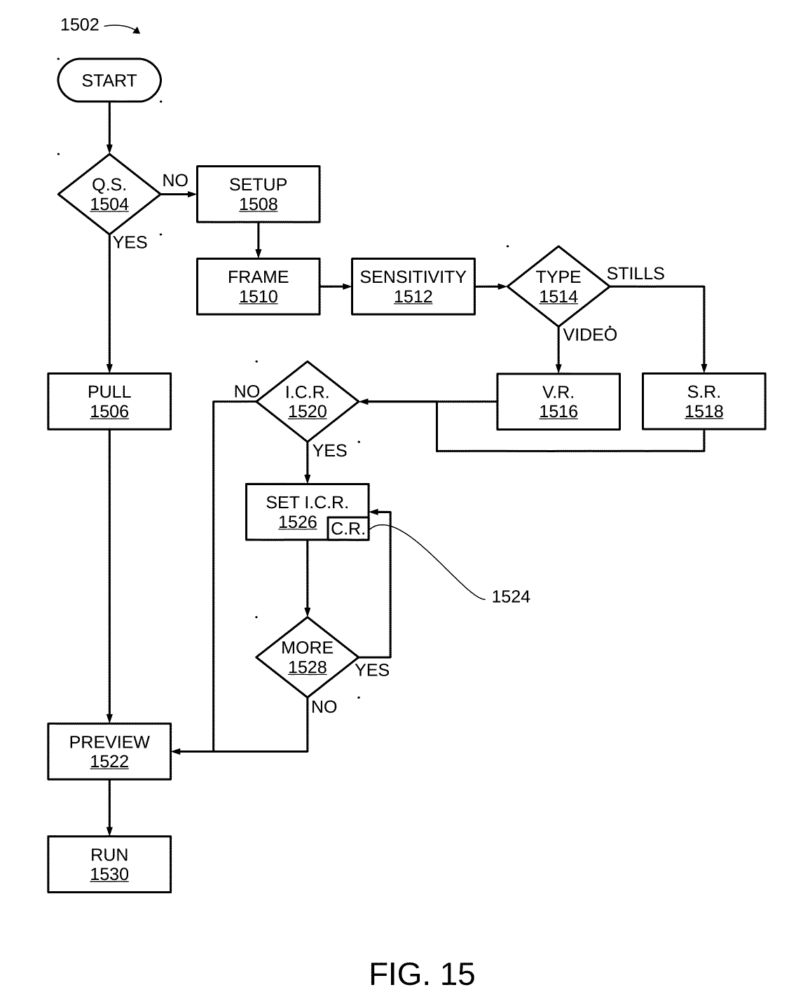

Referring now to FIG. 14, therein is shown an editing control flow 1402 for an embodiment of the image recording system 100 of FIG. 1. The editing control flow 1402 can include a load step 1404.

The load step 1404 can take the images 304 of FIG. 3 captured by the camera modules 102 of FIG. 1 and load them onto a single user device 206 of FIG. 2. It is contemplated that the images 304 can be loaded using the I/O block 610 of FIG. 6 for the camera modules 102 with a direct connection such as USB configurations, Firewire, eSATA, Thunderbolt, or other physical connections. It is also contemplated that the images 304 can be loaded from the I/O block 610 with wireless connections such as Bluetooth, IrDA, WUSB, or other wireless configurations.

Other methods of loading the images 304 include aggregating SD cards or memory cards and physically loading them onto the user device 206. The load step 1404 can also load the metadata 314 of FIG. 3 from the tag 104 of FIG. 1 and the camera modules 102 using the same methods that the images 304 are uploaded.

The load step 1404 can be completed and initiate a sort step 1406. The sort step 1406 can be initiated after the load step 1404 is completed or during the operation of the load step 1404. The sort step 1406 can sort the images 304 and the metadata 314 according to the camera modules 102 capturing the images 304 and the time the images 304 were captured. The sort step 1406 can further sort the metadata 314 based on the camera modules 102 or the tags 104 capturing the metadata 314 along with the time the metadata 314 was captured or recorded.

The images 304 and metadata 314 that are sorted in the sort step 1406 can be displayed on the display 204 of FIG. 2 of the user device 206 in a display step 1408 as is depicted in FIG. 3. The user 120 of FIG. 1 can engage a filter step 1410 by selecting one or more of the images 304 and engaging the filter buttons 324 of FIG. 3 to determine whether the images 304 should be retained or discarded. For example, the user 120 could select a set of the burst sequence images 308 of FIG. 3 and then select the “Not Hot” filter button 324 to discard the burst sequence images 308.

Once the images 304 have been filtered in the filter step 1410, the transitions 406 of FIG. 4 can be added in a transition step 1412. It is contemplated that the transitions 406 can be added between two of the images 304 captured by different camera modules 102 or the transitions 406 can be added between two different types of the images 304.

During the transition step 1412, the user 120 could manually add the transitions 406. Further, the user device 206 could automatically add the transitions 406 and the user 120 could filter the transitions 406 in the same way the user filters the images 304 in the filter step 1410. The user device 206 can then combine the images 304 and the transitions 406 in a merge step 1414 to create a single sequence of the images 304 and the transitions 406.

Referring now to FIG. 15, therein is shown a setup control flow 1502 for an embodiment of the image recording system 100 of FIG. 1. Many features of the setup control flow 1502 can be implemented with the setup display 202 of FIG. 2.

The setup control flow 1502 can include a quick shoot decision box 1504. The quick shoot decision box 1504 can provide the user 120 of FIG. 1 with the decision to use previously chosen or previously used capture rule. If the result of the quick shoot decision box 1504 is “YES”, a pull step 1506 can be initiated to pull the previously used or previously chosen capture rules for capturing the images 304 of FIG. 3.

If the result of the quick shoot decision box 1504 is “NO”, a setup menu step 1508 can be initiated to display a setup menu, for example the setup display 202. Once the setup menu step 1508 displays a setup menu, a frame setup step 1510 can be initiated. The frame setup step 1510 can be used to set the height 210 of FIG. 2 of the frame 122 of FIG. 1 around the tag 104 of FIG. 1. The frame setup step 1510 can also be used to set up the placement 212 of the frame 122 about the tag 104.

Once the frame setup step 1510 has been used to set up the frame 122, a sensitivity setup step 1512 can be initiated to determine the sensitivity of movement required to initiate the capture step 724 of FIG. 7. In one contemplated embodiment, the sensitivity could be set to low, medium, or high. In other contemplated embodiments, the sensitivity setup step 1512 can be combined with later steps when setting up thresholds for the capture step 724.

A recording type decision step 1514 can be initiated in order to determine which types of the images 304 the user 120 desires to capture. For example, the recording type decision step 1514 can include selections for the motion videos 306 of FIG. 3, the burst sequence images 308 of FIG. 3, the burst images 310 of FIG. 3, the still images 312 of FIG. 3, or a combination thereof.

In one exemplary embodiment, the motion videos 306 can be selected in the recording type decision step 1514 and initiate a motion video resolution step 1516. It is contemplated that the motion video resolution step 1516 can allow the user 120 to select from multiple resolutions including 720p, 1080p. Further the motion video resolution step 1516 can include selections allowing the user 120 to select frame rate, such as 30, 60, or 120 frames per second.

If on the other hand, the images 304 selected are the still images 312, the recording type decision step 1514 can initiate a still image resolution step 1518. It is contemplated that the still image resolution step 1518 can allow the user 120 to select from multiple resolutions including 2 mp, 5 mp, or 10 mp. Further it is contemplated that when the burst sequence images 308 or the burst images 310 are selected as the type of images 304 to be captured, an additional selection for the frame rate can be presented to the user 120 similar to the frame rate of the motion video resolution step 1516 such as 30, 60, or 120 frames per second.

Once the motion video resolution step 1516 or the still image resolution step 1518 are complete, an image capture rule decision box 1520 can be initiated to determine whether image capture rules need to be set. If the result of the image capture rule decision box 1520 is “NO”, then a preview step 1522 can be initiated to preview the image capture, the height 210 of the frame 122 and the placement 212 of the frame 122. The preview step 1522 can also be initiated after the pull step 1506 is completed.

If the result of the image capture rule decision box 1520 is “YES”, the user 120 has selected to set up a capture rule 1524 in a capture rule setup step 1526. The capture rule 1524 can be the distance threshold 732 of FIG. 7, the sensor threshold 738 of FIG. 7, or the location thresholds 1006 of FIG. 10.

Illustratively, the capture rule 1524 can be set for the location of the tag 104 relative to the camera modules 102 of FIG. 1, the velocity of the tag 104 or the camera module 102, the distance 124 between the tag 104 and one of the camera modules 102, an acceleration of the tag 104 or the camera module 102, or the spin rate of the tag 104 or the camera module 102. Setting the capture rule 1524 in the capture rule setup step 1526 will set the location threshold 1006, the sensor threshold 738, the distance threshold 732, or a combination thereof for the capture of the images 304 within the capture step 724.

After the capture rule 1524 is set up in the capture rule setup step 1526, a more capture rules decision step 1528 can be initiated. If the result of the more capture rules decision step 1528 is “YES”, the capture rule setup step 1526 can be initiated again to set up additional capture rules 1524.

When the capture rule setup step 1526 is initiated more than once, multiple different capture rules 1524 can be set up for the capture of the images 304. For example, the sensor threshold 738 can be set for 2 g′s of upward force along with a 500 degree/second spin rate while the distance threshold 732 can be set for 9 meters. When both of the sensor thresholds 738 are crossed and when the distance 124 between the tag 104 and the camera modules 102 crosses the distance threshold 732 by being less than 9 meters, the camera modules 102 will capture the images 304.

If the result of the more capture rules decision step 1528 is “NO”, the preview step 1522 can be initiated to preview the image capture with the capture rule 1524, the height 210 of the frame 122 and the placement 212 of the frame 122. If the user 120 determines the preview is acceptable a run step 1530 can be initiated. The run step 1530 can include the predict location step 714 of FIG. 7, the calculate location step 716 of FIG. 7, the capture step 724 of FIG. 7, and the adjust step 726 of FIG. 7 along with other steps disclosed herein.

Thus, it has been discovered that the image recording system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the image recording system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A method of image capture comprising:
providing a threshold;
receiving a signal with a camera module, the signal being from a tag;
determining a location of the tag relative to the camera module based on receiving the signal from the tag, and determining the location includes determining a distance between the tag and the camera module;
capturing an image based on the threshold being crossed and the tag being within a frame o f the camera module; and
recording metadata for the image.

2. The method of claim 1 further comprising:
adjusting the camera module and maintaining consistent placement of the tag within the frame based on the location of the tag;
adjusting a zoom of the camera module and maintaining a consistent height of the frame based on the distance;
adjusting a focus of the camera module based on the distance; or
a combination thereof.

3. The method of claim 1 wherein capturing the image includes capturing a motion video, burst images, still images, or a combination thereof.

4. The method of claim 1 wherein capturing the image based on the threshold being crossed includes capturing the image based on a distance threshold being crossed.

5. The method of claim 1 wherein capturing the image based on the threshold being crossed includes capturing the image based on a sensor threshold being crossed.

6. The method of claim 1 wherein capturing the image based on the threshold being crossed includes capturing the image based on a location threshold being crossed.

7. The method of claim 1 further comprising:
sorting the image based on the metadata; and
displaying the image for enabling a user to filter the image.

8. A non-transitory computer readable medium, useful in association with a processor, including instructions configured to:
provide a threshold;
receive a signal with a camera module, the signal being from a tag;
determine a location of the tag relative to the camera module based on receiving the signal from the tag, and determining the location includes determining a distance between the tag and the camera module;
capture an image based on the threshold being crossed and the tag being within a frame o f the camera module; and
record metadata for the image.

9. The computer readable medium of claim 8 further comprising instructions configured to:
adjust the camera module and maintaining consistent placement of the tag within the frame based on the location of the tag;
adjust a zoom of the camera module and maintaining a consistent height of the frame based on the distance;
adjust a focus of the camera module based on the distance; or
a combination thereof.

10. The computer readable medium of claim 8 wherein the instructions configured to capture the image includes the instructions configured to capture a motion video, burst images, still images, or a combination thereof.

11. The computer readable medium of claim 8 wherein the instructions configured to capture the image based on the threshold being crossed includes the instructions configured to capture the image based on a distance threshold being crossed.

12. The computer readable medium of claim 8 wherein the instructions configured to capture the image based on the threshold being crossed includes the instructions configured to capture the image based on a sensor threshold being crossed.

13. The computer readable medium of claim 8 wherein the instructions configured to capture the image based on the threshold being crossed includes the instructions configured to capture the image based on a location threshold being crossed.

14. The computer readable medium of claim 8 further comprising instructions configured to:
sort the image based on the metadata; and
display the image for enabling a user to filter the image.

15. A system for image capture comprising:
a tag; and
a camera module including:
a communications block configured to receive a signal from the tag;
a control block configured to provide a threshold, determine a location of the tag relative to the camera module based on receiving the signal from the tag, the location including a distance between the tag and the camera module;
a sensor block configured to capture an image based on the threshold being crossed and the tag being within a frame of the camera module; and
a storage block configured to record metadata for the image.

16. The system of claim 15 further comprising a drive block configured to adjust the camera module and maintain a consistent placement of the tag within the frame based on the location of the tag, adjust a zoom of the camera module and maintain a consistent height of the frame based on the distance, adjust a focus of the camera module based on the distance, or a combination thereof.

17. The system of claim 15 wherein sensor block configured to capture an image is configured to capture a motion video, burst images, still images, or a combination thereof.

18. The system of claim 15 wherein the sensor block is configured to capture the image based on a distance threshold being crossed.

19. The system of claim 15 wherein the sensor block is configured to capture the image based on a sensor threshold being crossed.

20. The system of claim 15 wherein the sensor block is configured to capture the image based on a location threshold being crossed.
